(19) United States
(12) Patent Application Publication
(10) Pub. No.: US 2008/0163234 A1
(43) Pub. Date: Jul. 3, 2008

(54) METHODS AND SYSTEMS FOR IDENTIFYING APPLICATION SYSTEM STORAGE RESOURCES

(75) Inventors: William Stronge, Littleton, MA (US); Robert Strechay, Littleton, MA (US); Kevin Faulkner, Littleton, MA (US); Richard Corley, Littleton, MA (US); David Kaeli, Littleton, MA (US)

Correspondence Address: JACOBS & KIM LLP, 1050 WINTER STREET, SUITE 1000, #1082, WALTHAM, MA, 02451-1401, US

(73) Assignee: AKORRI NETWORKS, INC.

(21) Appl. No.: 11/961,186

(22) Filed: Dec. 20, 2007

Related U.S. Application Data
(63) Continuation-in-part of application No. 11/773,825, filed on Jul. 5, 2007.
(60) Provisional application No. 60/871,444, filed on Dec. 21, 2006.
(60) Provisional application No. 60/806,699, filed on Jul. 6, 2006.

(51) Int. Cl. G06F 9/46

(52) U.S. Cl. 718/104

(57) ABSTRACT

The invention provides methods, apparatus, systems and computer program code (software) products operable in a digital processing environment, and more particularly a digital storage environment, for enabling a mapping from a set of applications to storage elements used in the digital storage environment, and to provide a hierarchical image of a set of applications (other software programs) that are generating load on any storage element in the digital storage environment.

### CROSS-REFERENCE TO RELATED APPLICATIONS

This application for patent claims the priority benefit of U.S. Provisional Patent Application Ser. No. 60/871,444 filed Dec. 21, 2006 (Attorney Docket: AKR-114-PR), entitled “Methods and Systems for Identifying Application System Storage Resources”, which is incorporated by reference herein as if set forth in its entirety.

This application for patent is also a Continuation-in-Part (CIP) of U.S. patent application Ser. No. 11/773,825 filed Jul. 5, 2007 (Attorney Docket AKR-110-US), entitled “Managing Application System Load”, which is also incorporated by reference herein, and whose Detailed Description and drawings are set forth herein. U.S. patent application Ser. No. 11/773,825 (AKR-110-US) in turn claims the priority benefit of U.S. Provisional Patent Application Ser. No. 60/806,699 filed Jul. 6, 2006 (AKR-110-PR), which is incorporated herein by reference as if set forth in its entirety.

### FIELD OF THE INVENTION

The present invention relates generally to digital processing systems, devices, and networks, and more particularly, to the field of application performance and self-managing systems. Still more particularly, it relates to methods, systems and devices for mapping performance problems experienced in system resources back to application servers, applications and application tasks that are producing load on a performance-constrained system resource.

### BACKGROUND OF THE INVENTION

Many storage platforms allow a storage administrator to allocate and assign storage resources to different hardware servers. A single hardware server can run multiple applications concurrently. A single application can embody a number of concurrent tasks. A single application will typically utilize a number of system resources. Application performance can potentially be accelerated if access to an application's system resources can be optimized.

Unfortunately, in conventional storage platforms, the user or system administrator has little guidance as to how individual applications utilize a set of system resources. It may be the case that two applications running concurrently on the same hardware server are stalled due to contention for a common system resource. While system resource contention can be identified, unless we can identify the mapping from an application to the system resources it is using, and vice-versa, we may attempt to remedy a performance bottleneck without full knowledge of the cause of the problem.

More particularly, applications are often hosted on servers that share a common storage system through a Storage Area Network (SAN). Imbalance between the demands of the applications and the capabilities of the centralized storage can result in poor overall performance of the applications sharing the centralized storage resource. This imbalance can also impact an application's use of any of a number of different system elements including servers (CPUs and memory), bus adapters, switches, disk controllers and disk arrays.

Individual applications can experience a performance impact if they place too much load on any particular system element in the path between the server and the supporting storage subsystem. Further, multiple applications running on the same or independent servers can impact each other's performance when networks and storage are shared among applications and servers, as SANs are often deployed as a shared resource.

Performance of any application can be degraded if an application generates too much load on a single device, or if multiple applications flood the system with many requests, such that the storage system is not able to service the aggregate load.

The interference generated by one application on another when accessing storage systems can result in large variations in performance. Attempts to provide more predictable application performance often result in the over-provisioning of a system resource (e.g., CPUs, memory, networks, disks).

One known way of addressing some of the resource-related issues of storage platforms is Storage Resource Management (SRM), which typically provides instrumentation to discovery the topology of, and assesses the performance health of, a set of allocated resources. A system's performance health can be measured in terms of response time and storage bandwidth. An SRM can detect performance-constrained storage resources, and report this to the storage administrator.

To be able to identify the set of applications that exercise a particular set of networked storage resources, a complete mapping between the storage system and the application is required. The mapping must include both (1) information about all systems resources (e.g., individual disks, disk controllers, bus adapters) used by applications and (2) the path from the storage system to the application server (including volume-LUN mapping, and network switches).

By way of example, U.S. Pat. No. 7,058,545 (“the '545 patent”), incorporated by reference herein, describes a method for identifying the logical and physical data paths between the storage devices and an application, but without the ability to identify all of the system resources that make up the path. The '545 patent is directed to managing the data path to increase the performance, reliability or security of the data path, and it does not address contention between multiple applications.

Accordingly, it would be useful to provide methods and systems operable to effectively map system resources to applications, particularly in real-world environments in which multiple applications are running.

It would also be useful to provide improved storage platforms and architectures utilizing such methods and systems.

The present invention, which meets these needs and provides other technical advantages and features, will next be described in detail, in connection with the attached drawing figures.

### SUMMARY OF THE INVENTION

The invention provides methods, apparatus, systems and computer program code (software) products operable in a digital processing environment, and more particularly a digital storage environment, for enabling a mapping from a set of applications to storage elements used in the digital storage environment, and to provide a hierarchical image of a set of applications (other software programs) that are generating load on any storage element in the digital storage environment.

By way of example, one aspect of the invention provides such methods, apparatus, systems and computer program code (software) products that are operable in a digital storage environment comprising (A) at least one Application Server, Bus Adapter, Network Switch, Disk Controller, and Disk Array, the at least one Application Server, Bus Adapter, Network Switch, Disk Controller and Disk Array collectively being Storage Elements in the digital storage environment; and (B) at least two Applications. This aspect of the invention comprises:

(A) providing an Application Resource Group (ARG) operable to provide mapping from a set of Applications to Storage Elements used in the digital storage environment, wherein the ARG comprises ARG abstractions, the ARG abstractions comprising at least one of:

an Application Server Group (ASerG) operable to identify an Application placing load on a Server;

an Application Adapter Group (AAG) operable to identify an Application placing load on a Bus Adapter;

an Application Switch Group (ASwG) operable to identify Applications placing load on a Network Switch;

an Application Controller Group (ACG) operable to identify an Application placing load on a Disk Controller; and

an Application Storage Group (ASG) operable to identify an Application placing load on a Disk Array; and

(B) defining a Subgroup operable to refine the granularity of the relationship between a single Storage Element and an Application, wherein each ARG abstraction contains at least one Subgroup,

wherein the ARG and Subgroup are collectively operable to provide a mapping from a set of Applications to Storage Elements used in the digital storage environment, and to provide a hierarchical image of a set of Applications that are generating load on any Storage Element in the digital storage environment.

In another aspect of the invention, the ARG and Subgroup are collectively operable to provide a substantially complete mapping from a set of Applications to Storage Elements used in the digital storage environment.

In another aspect of the invention, the ARG and Subgroup are collectively operable such that when multiple applications compete for a single Storage Element and create a bottleneck, the ARG can identify the set of Applications that may be the cause of the bottleneck.

In still another aspect of the invention, ASG abstractions are configured such that a single Subgroup can only be present in a single ASG abstraction.

Further details, examples, and embodiments are described in the following Detailed Description, to be read in conjunction with the attached drawings.

As noted above, the present invention is a Continuation-in-Part (CIP) of U.S. patent application Ser. No. 11/773,825 filed Jul. 5, 2007 (Attorney Docket AKR-110-US), entitled “Managing Application System Load”; and thus, the following Detailed Description first describes the invention of Ser. No. 11/773,825 (AKR-110-US) (Sections A-D below) and then proceeds with a description of the present invention (Sections E and F below). Those skilled in the art will appreciate that the digital processing, computing or storage environments described in Ser. No. 11/773,825 (AKR-110-US) are just some of the examples of processing environments in which the present invention may be practiced, and will also appreciate that the present invention can be practiced in environments other than those described in Ser. No. 11/773,825 (AKR-110-US).

### BRIEF DESCRIPTION OF THE DRAWINGS

Those skilled in the art will readily understand the present invention based on the following Detailed Description, taken in connection with the attached drawings, in which:

FIG. 1 (Prior Art) is a schematic diagram of a conventional workstation or PC (personal computer) digital computing system, on which the present invention may be implemented; or which may form a part of a networked digital computing system on which the present invention may be implemented.

FIG. 2A (Prior Art) is a schematic diagram of a networked digital computing system on which the present invention may be implemented.

FIG. 2B (Prior Art) is a schematic diagram of components of a conventional workstation or PC environment like that depicted in FIG. 1.

FIG. 3 is a schematic diagram of one embodiment of the present invention.

FIG. 4 is a schematic diagram of a digital computing system in which the present invention may be implemented.

FIG. 5 is a schematic diagram depicting an application program with adjustable application parameters.

FIG. 6 is schematic diagram of an application running on the digital computing system and generating a system load.

FIG. 7 is a schematic diagram depicting a computing system and an Information Resource Manager (IRM) constructed in accordance with the present invention.

FIG. 8 is a schematic diagram depicting a database of performance statistics, configuration data and application parameters for applications running on the computing system.

FIG. 9 is a schematic diagram depicting how performance information can be obtained, in accordance with the present invention, from the computing system.

FIG. 10 is a schematic diagram depicting how configuration information can be obtained, in accordance with the present invention, from each element of the computing system.

FIG. 11 is a schematic diagram depicting the analytical model aspect of the IRM, in accordance with one embodiment of the present invention.

FIG. 12 is a schematic diagram depicting how configuration data, CPU statistics, network statistics and SAN statistics can be used to construct the analytical model in accordance with the present invention.

FIG. 13 is a schematic diagram depicting how the analytical model generates an updated set of application parameters in accordance with one practice of the present invention.

FIG. 14 is a schematic diagram depicting how the updated application parameters are used to update the set of application parameters used by the application, in accordance with one practice of the present invention.

FIG. 15 is a schematic diagram depicting how the information resource manager (IRM) can maintain a number of CPU, network and SAN statistics.

FIG. 16 is a schematic diagram depicting how multiple sets of updated statistics can be used to drive an analytical model, which then updates the application data running on the computing system, in accordance with the present invention.

FIG. 17 is a schematic block diagram of the major components of the ELM architecture in accordance with one embodiment of the present invention.

FIG. 18 is a diagram depicting the timing of the collection of statistics for the ELM architecture.

FIG. 19 is a table providing a summary of the collection and calculation frequencies for the ELM statistics.

FIGS. 20-27 are a series of tables providing a summary of the ELM statistics.

FIG. 28 is a schematic diagram depicting various connectors contained in the EDaC service in accordance with one practice of the present invention.

FIGS. 29A, 29B and 30 are flowcharts showing various method aspects according to present invention for optimizing execution of multiple applications running on a digital computing system.

FIG. 31 is a table, the column of which list levels, groups, and infrastructure elements according to a further aspect of the invention providing a multi-level mapping of application system storage resources.

FIG. 32 is a diagram of an exemplary computer infrastructure architecture suitable for practicing the described systems and techniques for multi-level mapping of application system storage resources.

FIGS. 33-37 are a series of diagrams illustrating Groups formed from subsets of the elements set forth in the FIG. 32 architecture.

FIG. 38 is a diagram of an alternative exemplary computer infrastructure architecture.

FIGS. 39A-B are diagrams illustrating Subgroups formed from subsets of the elements set forth in the FIG. 38 architecture.

FIG. 40 is a flowchart of a general technique, according to a further aspect of the invention, for multi-level mapping of application system storage resources.

### DETAILED DESCRIPTION OF THE INVENTION

The following description set forth numerous specific details to provide an understanding of the invention. However, those skilled in the art will appreciate that the invention may be practiced without these specific details. In other instances, well-known methods, procedures, components, protocols, algorithms, and circuits have not been described in detail so as not to obscure the invention. The following discussion describes various aspects of the invention, including those related to addressing load on storage resources, and aspects related to balancing CPU, network and SAN resources by properly adjusting application parameters.

As noted above, the present invention is a Continuation-in-Part (CIP) of U.S. patent application Ser. No. 11/773,825 filed Jul. 5, 2007 (Attorney Docket AKR-110-US), entitled “Managing Application System Load”; and thus, the following Detailed Description first describes the invention of Ser. No. 11/773,825 (AKR-110-US) (Sections A-D below) and then proceeds with a description of the present invention (Sections E and F below). Those skilled in the art will appreciate that the digital processing, computing or storage environments described in Ser. No. 11/773,825 (AKR-110-US) are just some of the examples of processing environments in which the present invention may be practiced, and will also appreciate that the present invention can be practiced in environments other than those described in Ser. No. 11/773,825 (AKR-110-US).

The present Detailed Description is organized into the following sections:
A. Digital Processing Environment in Which the Invention Can Be Implemented
B. Managing Application System Load
C. Managing Application System Load—Additional Implementation Details/Examples
   C1. System Architecture
   C2. The External Discovery Subsystem
   C3. Discovery Engine
D. Managing Application System Load—General Method
E. Multi-Level Mapping of Application System Storage Resources
F. Embodiments of Multi-Level Mapping
G. Conclusion

### A. DIGITAL PROCESSING ENVIRONMENT IN WHICH THE INVENTION CAN BE IMPLEMENTED

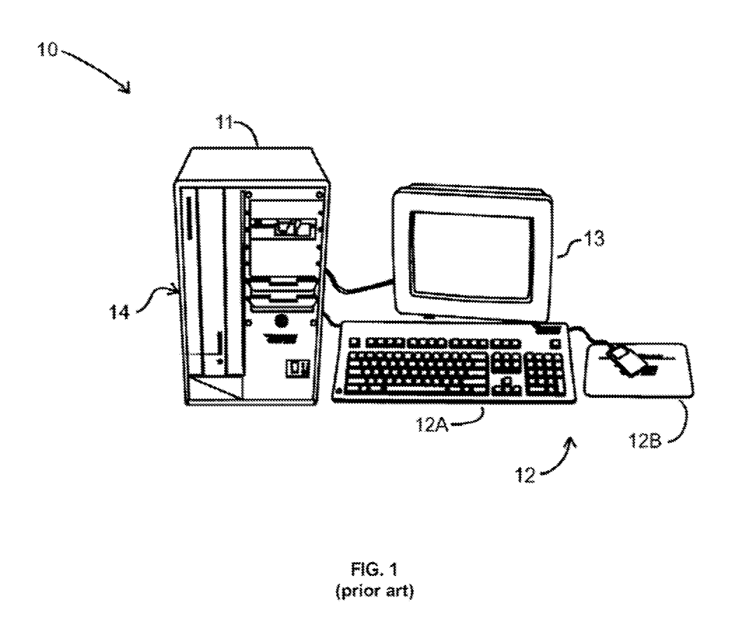

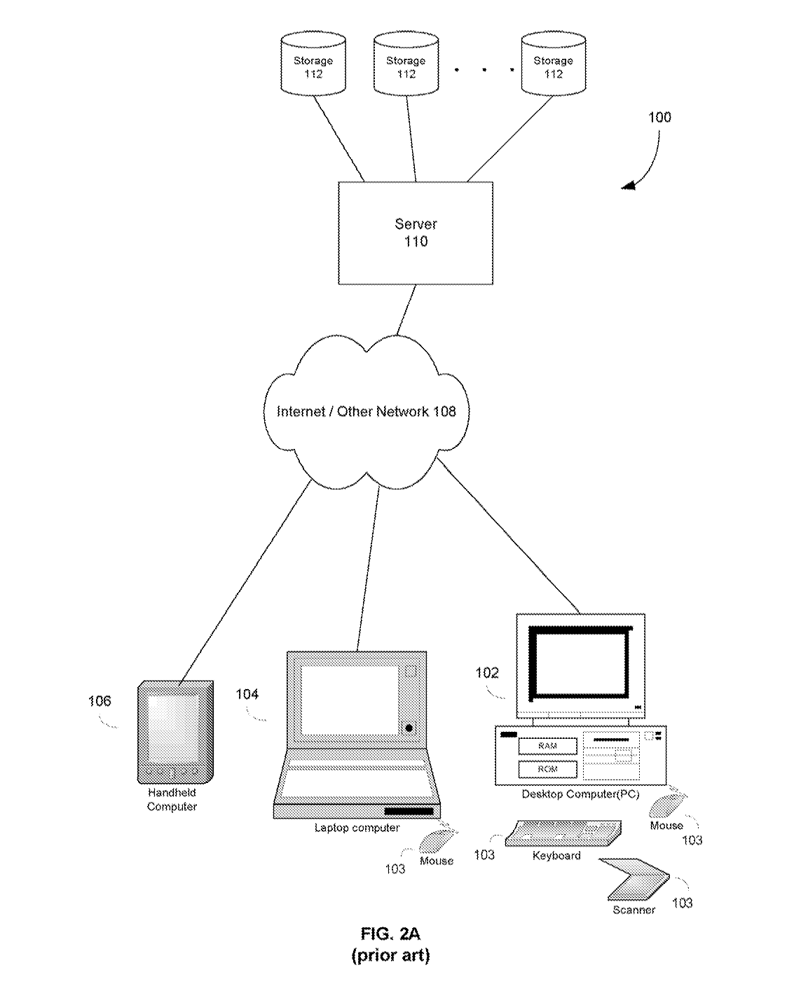

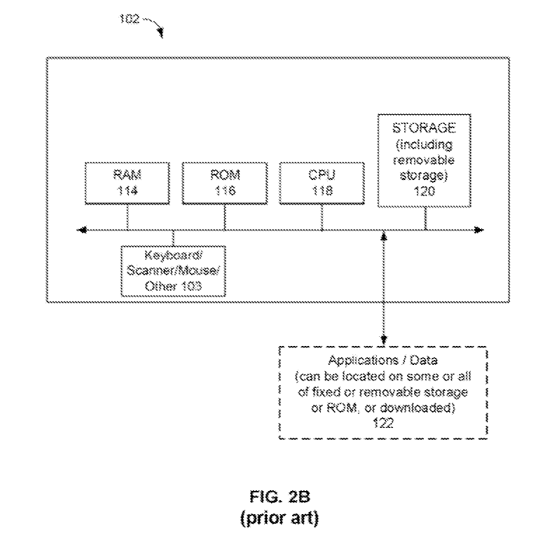

Before describing particular examples and embodiments of the invention, the following is a discussion, to be read in connection with FIGS. 1 and 2A-B, of underlying digital processing structures and environments in which the invention may be implemented and practiced.

It will be understood by those skilled in the art that the present invention provides methods, systems, devices and computer program products that enable more efficient application execution on applications commonly found on compute server class systems. These applications include database, web-server and email-server applications. These applications are commonly used to support a medium to large group of computer users simultaneously. These applications provide coherent and organized access and sharing by multiple users to a shared set of data. The applications can be hosted on multiple or a single shared set of digital computing systems. The set of tasks carried out on each application dictates the patterns and loads generated on the digital computing system, which can be managed through a set of configurable application parameters.

The present invention can thus be implemented as a separate software application, part of the computer system operating system software or as dedicated computer hardware of a computer that forms part of the digital computing system. The present invention may be implemented as a separate, stand-alone software-based or hardware-based system. The implementation may include user interface elements such as a keyboard and/or mouse, memory, storage, and other conventional user-interface components. While conventional components of such kind are well known to those skilled in the art, and thus need not be described in great detail herein, the following overview indicates how the present invention can be implemented in conjunction with such components in a digital computer system.

More, particularly, those skilled in the art will understand that the present invention can be utilized in the profiling and analysis of digital computer system performance and application tuning. The techniques described herein can be practiced as part of a digital computer system, in which performance data is periodically collected and analyzed adaptively. The data can further be used as input to an analytical model that can be used to project the impact of modifying the current system. The applications running on the digital computer system can then be reconfigured to improve performance.

The following detailed description illustrates examples of methods, structures, systems, and computer software products in accordance with these techniques. It will be understood by those skilled in the art that the described methods and systems can be implemented in software, hardware, or a combination of software and hardware, using conventional computer apparatus such as a personal computer (PC) or an equivalent device operating in accordance with (or emulating) a conventional operating system such as Microsoft Windows, Linux, or Unix, either in a standalone configuration or across a network. The various processing aspects and means described herein may therefore be implemented in the software and/or hardware elements of a properly configured digital processing device or network of devices. Processing may be performed sequentially or in parallel, and may be implemented using special purpose or re-configurable hardware.

As an example, FIG. 1 attached hereto depicts an illustrative computer system 10 that can run server-class applications such as databases and mail-servers. With reference to FIG. 1, the computer system 10 in one embodiment includes a processor module 11 and operator interface elements comprising operator input components such as a keyboard 12A and/or a mouse 12B (or digitizing tablet or other analogous element(s), generally identified as operator input element(s) 12) and an operator output element such as a video display device 13. The illustrative computer system 10 can be of a conventional stored-program computer architecture. The processor module 11 can include, for example, one or more processor, memory and mass storage devices, such as disk and/or tape storage elements (not separately shown), which perform processing and storage operations in connection with digital data provided thereto. The operator input element(s) 12 can be provided to permit an operator to input information for processing. The video display device 13 can be provided to display output information generated by the processor module 11 on a screen 14 to the operator, including data that the operator may input for processing, information that the operator may input to control processing, as well as information generated during processing. The processor module 11 can generate information for display by the video display device 13 using a so-called “graphical user interface” (“GUI”), in which information for various applications programs is displayed using various “windows.”

The terms “memory”, “storage” and “disk storage devices” can encompass any computer readable medium, such as a computer hard disk, computer floppy disk, computer-readable flash drive, computer-readable RAM or ROM element or any other known means of encoding digital information. The term “applications programs”, “applications”, “programs”, “computer program product” or “computer software product” can encompass any computer program product consisting of computer-readable programs instructions encoded and/or stored on a computer readable medium, whether that medium is fixed or removable, permanent or erasable, or otherwise. As noted, for example, in block 122 of the schematic block diagram of FIG. 2B, applications and data can be stored on a disk, in RAM, ROM, on other removable or fixed storage, whether internal or external, and can be downloaded or uploaded, in accordance with practices and techniques well known in the art. As will also be noted in this document, the present invention can take the form of software or a computer program product stored on a computer-readable medium, or it can be in the form of computer program code that can be uploaded or downloaded, or fixed in an FPGA, ROM or other electronic structure, or it can take the form of a method or a system for carrying out such a method. Although the computer system 10 is shown as comprising particular components, such as the keyboard 12A and mouse 12B for receiving input information from an operator, and a video display device 13 for displaying output information to the operator, it will be appreciated that the computer system 10 may include a variety of components in addition to or instead of those depicted in FIG. 1.

In addition, the processor module 11 can include one or more network ports, generally identified by reference numeral 14, which are connected to communication links which connect the computer system 10 in a computer network. The network ports enable the computer system 10 to transmit information to, and receive information from, other computer systems and other devices in the network. In a typical network organized according to, for example, the client-server paradigm, certain computer systems in the network are designated as servers, which store data and programs (generally, “information”) for processing by the other, client computer systems, thereby to enable the client computer systems to conveniently share the information. A client computer system which needs access to information maintained by a particular server will enable the server to download the information to it over the network. After processing the data, the client computer system may also return the processed data to the server for storage. In addition to computer systems (including the above-described servers and clients), a network may also include, for example, printers and facsimile devices, digital audio or video storage and distribution devices, and the like, which may be shared among the various computer systems connected in the network. The communication links interconnecting the computer systems in the network may, as is conventional, comprise any convenient information-carrying medium, including wires, optical fibers or other media for carrying signals among the computer systems. Computer systems transfer information over the network by means of messages transferred over the communication links, with each message including information and an identifier identifying the device to receive the message.

In addition to the computer system 10 shown in the drawings, methods, devices or software products in accordance with the present invention can operate on any of a wide range of conventional computing devices and systems, such as those depicted by way of example in FIGS. 2A and 2B (e.g., network system 100), whether standalone, networked, portable or fixed, including conventional PCs 102, laptops 104, handheld or mobile computers 106, or across the Internet or other networks 108, which may in turn include servers 110 and storage 112.

In line with conventional computer software and hardware practice, a software application configured in accordance with the invention can operate within, e.g., a PC 102 like that shown in FIGS. 1 and 2A-B, in which program instructions can be read from ROM or CD ROM 116 (FIG. 2B), magnetic disk or other storage 120 and loaded into RAM 114 for execution by CPU 118. Data can be input into the system via any known device or means, including a conventional keyboard, scanner, mouse, digitizing tablet, or other elements 103. As shown in FIG. 2B, the depicted storage 120 includes removable storage. As further shown in FIG. 2B, applications and data 122 can be located on some or all of fixed or removable storage or ROM, or downloaded.

Those skilled in the art will understand that the method aspects of the invention described herein can be executed in hardware elements, such as a Field-Programmable Gate Array (FPGA) or an Application-Specific Integrated Circuit (ASIC) constructed specifically to carry out the processes described herein, using ASIC construction techniques known to ASIC manufacturers. The actual semiconductor elements of a conventional ASIC or equivalent integrated circuit or other conventional hardware elements that can be used to carry out the invention are not part of the present invention, and will not be discussed in detail herein.

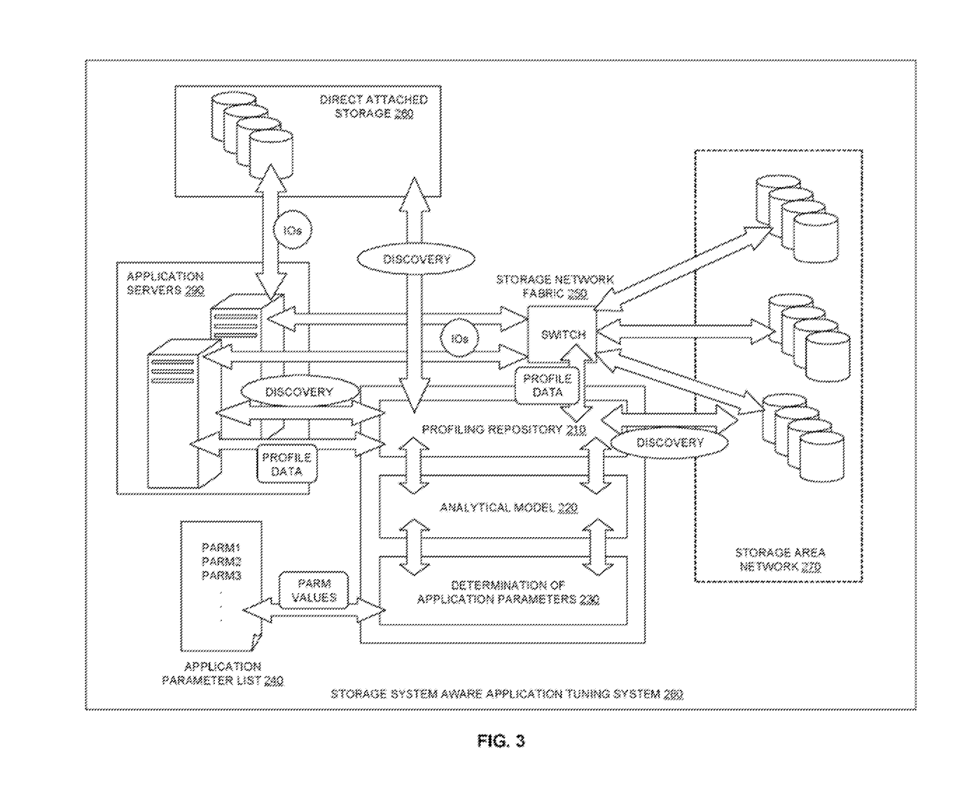

Those skilled in the art will also understand that ASICs or other conventional integrated circuit or semiconductor elements can be implemented in such a manner, using the teachings of the present invention as described in greater detail herein, to carry out the methods of the present invention as shown, for example, in FIG. 3 et seq., discussed in greater detail below.

Those skilled in the art will also understand that method aspects of the present invention can be carried out within commercially available digital processing systems, such as workstations and personal computers (PCs), operating under the collective command of the workstation or PC's operating system and a computer program product configured in accordance with the present invention. The term “computer program product” can encompass any set of computer-readable programs instructions encoded on a computer readable medium. A computer readable medium can encompass any form of computer readable element, including, but not limited to, a computer hard disk, computer floppy disk, computer-readable flash drive, computer-readable RAM or ROM element, or any other known means of encoding, storing or providing digital information, whether local to or remote from the workstation, PC or other digital processing device or system. Various forms of computer readable elements and media are well known in the computing arts, and their selection is left to the implementer.

### B. MANAGING APPLICATION SYSTEM LOAD

We will next describe examples and embodiments of systems and techniques for managing application system load according to various aspects of the invention set forth in Ser. No. 11/773,825 (AKR-110-US), of which the present application is a Continuation-in-Part (CIP).

Applications are commonly hosted on servers that share a common network and storage system through a storage area network (SAN). Imbalance between the demands of the applications and the capabilities of the CPUs, network and SAN has resulted in poor overall performance of the applications sharing the centralized resources. However, individual applications can experience a performance impact if they place too much load on any single element in the subsystem, and particularly the SAN. Further, CPUs, networks and storage arrays are often employed as a shared resource. Multiple applications running on independent servers can impact each other's performance when subsystem elements are shared among applications.

Many applications have internal parameters, which can be set by a user or by a system administrator, which can have a dramatic impact on an application's performance and throughput. The user typically does not consider the bandwidth sustainable or the parallelism present in the computing system configuration when an application is being initialized to run. A set of default values is commonly used to set the system load. These default values may include, for example, the number of threads, individual application priorities, storage space, and log buffer configuration. These values can also be adjusted during run time. While the values are adjustable by the user, application programmer, or system administrator, there is no guidance provided to adjust the application load in order to better match the characteristics of the underlying computing system resources.

Performance of any application can be degraded if an application generates too much traffic for a single device, or if multiple applications flood the system with many requests such that the system is not able to service the aggregate load. The interference generated by one application on another when any element in the system is overloaded can result in large variations in performance. Attempts to provide more predictable application performance often result in the over-provisioning capacity in a particular element in the subsystem.

In attempts to solve, or at least minimize, these problems, system administrators can request that each application has a fixed priority. The priority setting is used to “throttle” the application's demands on the system resources. Unfortunately, assigning a fixed priority can waste resources, and can also lead to application starvation. An alternative to throttling is to manage the quality of service (“QoS”) that each application experiences. The allocation of storage resources may be based upon various criteria, for example, the bandwidth of storage accesses. United States Published Patent Application No. 2005/0089054, which is incorporated herein by reference in its entirety, describes an apparatus for providing QoS based on an allocation of resources.

Conventional solutions to the concerns noted above have typically presented their own performance constraints and concerns. Therefore, it would be desirable to provide improved methods, devices, software and systems to more efficiently and flexibly manage the system load generated by an application or applications.

Instead of allocating disks or bandwidth to individual servers or applications, the systems and techniques described herein utilize the internal tuning facilities provided by an application, and arrive at tuned set of parameters based on the characteristics of the storage subsystem provided. Further, the present invention can also consider the resources of a complete digital computer system, such as a networked digital computing system. The described systems and techniques make use of existing performance monitoring systems and techniques that have been developed in commercial operating systems, such as Microsoft Windows, Linux and Unix. The described systems and techniques make use of existing interfaces to key database and email applications that enable adaptively tuning the application through a set of runtime parameters. The invention can further manage multiple applications concurrently, providing QoS guarantees through a careful provisioning of the available system resources.

Previous methods used to configure the application parameters that determine system performance suffer from a number of significant shortcomings: (1) tuning methods used to date have been based on trial-and-error iterative tuning, (2) users have had little information about the underlying CPU, network and storage subsystem to guide their tuning choices, (3) there has been little consideration given to managing multiple applications or multiple servers concurrently that utilize a shared digital computing system, and (4) there is presently no accepted methodology for translating the characteristics of a digital computing system to changes in individual application parameters.

Some applications are sensitive to the latency of storage access operations while others are not. Database and mail-server applications are particularly sensitive to the latency associated with storage access operations because they often access data in non-sequential modes and must sometimes await the completion of an access, or series of accesses, before issuing another command.

Many latency-sensitive applications, such as database systems, mail servers, and the like, have the ability to perform self-tuning. For instance, Oracle10g provides a query optimizer that can accelerate the performance of future queries based on the behavior of recent queries. Also, Oracle10g has over 250 tunable parameters that can affect database performance. These parameters can affect both the utilization of memory resources, e.g., caches and buffers, as well as define the amount of concurrent access possible, e.g., threading.

The described systems and techniques target the proper setting of these internal parameters by utilizing information about the underlying CPU, network and storage subsystems. As described herein, the CPU subsystem information includes both the type and number of processors being used, along with their associated memory hierarchy, the network subsystem information includes the speed and configuration of the network switch used and the speed of the adapters connected to the switch, and the storage subsystem information includes the characteristics of the physical disk devices, the grouping of these devices into RAID groups, the mapping of logical addresses to RAID groups, and the throughput of individual paths through this system. A further aspect of the invention provides the capability to obtain storage subsystem information by capturing runtime characteristics of the system. This information can be obtained by running customized exercisers or by observing the normal execution of the system.

The tuning of the application parameters may be done either upon initialization of the application, or dynamically. The methods used to capture the different characteristics of the underlying subsystem performance can be static, i.e., predetermined and shipped with the storage system, or acquired dynamically through profiling. The presently described invention includes methods to both specify this information statically, and obtain this information through profiling. According to a further aspect of the invention, this information is provided as feedback to an application to allow system parameters to be adjusted automatically or by a system/application administrator.

The above discussion describes the need to properly adjust the parameters of performance-sensitive applications in order to make best use of the digital computing resources. An embodiment of an apparatus and system for adjusting such parameters is shown in FIG. 3.

As shown in FIG. 3, application servers 290 access a variety of storage elements, some directly connected to the servers 260, and some connected to the servers via a storage area network 270 using a switch fabric 250. This is just one possible organization of servers and storage systems. The present invention does not require a particular organization.

Accordingly to the presently described aspect of the invention, an element is introduced that can communicate with both the servers and the storage system. This element is referred to herein as the Storage System Aware Application Tuning System (SSAATS) 280. This element and like structures and functions are also described and referred to below as the Information Resource Management (IRM) system. As described below, further aspects of the invention provide other named elements that perform some or all of the functions of the SSAATS element.

The embodiment of SSAATS shown in FIG. 3 contains three sub-elements:

(1) the storage network profiling system 210,

(2) an analytical model 220, and

(3) the application parameter determination subsystem 230.

The SSAATS element 280 can be implemented as a stand-alone subsystem, or can be integrated as part of the server subsystem 290 or the network fabric subsystem 240.

The profiling subsystem element 100 has the ability to determine the degree of parallelism in the storage network, and can deduce the bandwidth and latency values for the underlying storage system 260 and 270 as discussed above. The profiling subsystem element 210 can also determine the bandwidth and latency values for the network fabric elements 250 present.

The profiling subsystem element 210 obtains performance-related information that is not always available from the storage system manufacturer. When a storage system is installed, the available storage can be configured in many different organizations. Thus, even if some performance-related information is provided by the manufacturer, the majority of the information that is needed is only relevant after the storage system has been installed and configured.

The necessary performance-related information includes, for example, but is not limited to:

(1) the degree of parallelism that is available in the CPU, network, and SAN,

(2) the speed of the various devices,

(3) the bandwidth of the paths between the application server, the network and the individual storage devices, and

(4) the configuration of the storage devices as viewed from the server.

To obtain the necessary performance-related information, a series of input/output commands can be issued to the storage subsystem. Based on the response time and throughput of particular command sequences, the necessary performance-related information can be obtained. This information is then fed to the analytical model element 220.

The analytical model element 220 obtains profile information from the profiling storage network 210. The profiling data is consumed by an analytical performance model 220 that is used to establish the appropriate loads that the CPU subsystem on the application server 290, the network subsystem 250, and the storage subsystem 260 and 270 can sustain. The output of the analytical model element 220 is fed to the element that determines the parameter values 230, which then communicates these values to the application servers 290, which in turn will set internal parameters in the application.

An optional embodiment is to allow the profiling system to continue to profile the performance of storage system through the profiling network 210, to feed dynamic profiles to the analytical performance model 220, and to communicate a new set of application parameters from the parameter determination system 230 to the application servers 290. Key features of this optional embodiment include: (a) the profiling system cannot introduce significant overhead into the digital computing system, which might reduce the benefits obtained through parameter modifications, and (b) the system must make sure that appropriate control is provided to throttle the frequency of parameter modifications so that the system does not continually adapt to performance transients.

An optional embodiment is to allow the profiling system 210 to communicate directly with the storage resources 260 and 270 through a network interface, referred to herein as “Discovery,” in order to further refine the usage of the available system configuration.

The analytical model 220 described herein utilizes standard queuing theory techniques, and establishes how much load the storage subsystem can support. In particular, analytical model 220 can apply known queuing theory equations, algorithms and techniques to determine a supportable storage load. Such equations, algorithms and techniques are described, by way of example, in Kleinrock, L., Queueing Systems: Volume I—Theory (Wiley Interscience, New York, 1975); Kleinrock, L., Queueing Systems: Volume II—Computer Applications (Wiley Interscience, New York, 1976), both incorporated herein by reference as if set forth in their entireties herein. The parameter determination element then translates these load values into the specific parameter values of the target application. According to a further aspect of the invention, the SSAATS 280 contains multiple parameter determination elements 230, one per application software.

The determination of application parameters unit 230 will consider a range of application-specific parameters. One particular set of parameters includes, for example, the Cost-Based Optimization (CBO) parameters provided inside of Oracle 10g. These parameters can control how indexing and scanning are performed within Oracle, as well as the degree of parallelism assumed by the application. For example, the multi-block read count can be set to adjust the access size or set parallel automatic tuning to run parallelized table scans.

In many situations, it may be beneficial for a storage administrator to segregate applications by latency sensitivity. While the presently described mechanism is targeted to throttle an individual application's system resource requests, since the network and storage is commonly shared across different applications, the same system can be used to manage multiple applications.

If network and storage is shared across different applications, the analytical model 220 can be adjusted to capture the impact of competing application workloads. Two typical workloads would be an online transaction processing workload competing with a storage backup workload. While the backup application is performing critical operations, execution should favor the online transaction processing application.

If multiple applications are sharing the same set of 10 storage resources 260 and 270, then the determination of application parameters unit 230 will need to adjust multiple sets of parameter values to facilitate sharing.

When multiple applications share the same set of 10 storage resources 260 and 270, and if the user of system administrator desires to prioritize the throughput of each application, the determination of application parameters unit 230 can further adjust parameter values to favor one application's 10 requests over another.

There is now described a further embodiment of a system according to the present invention, in which the above-described elements and others are described in greater detail.

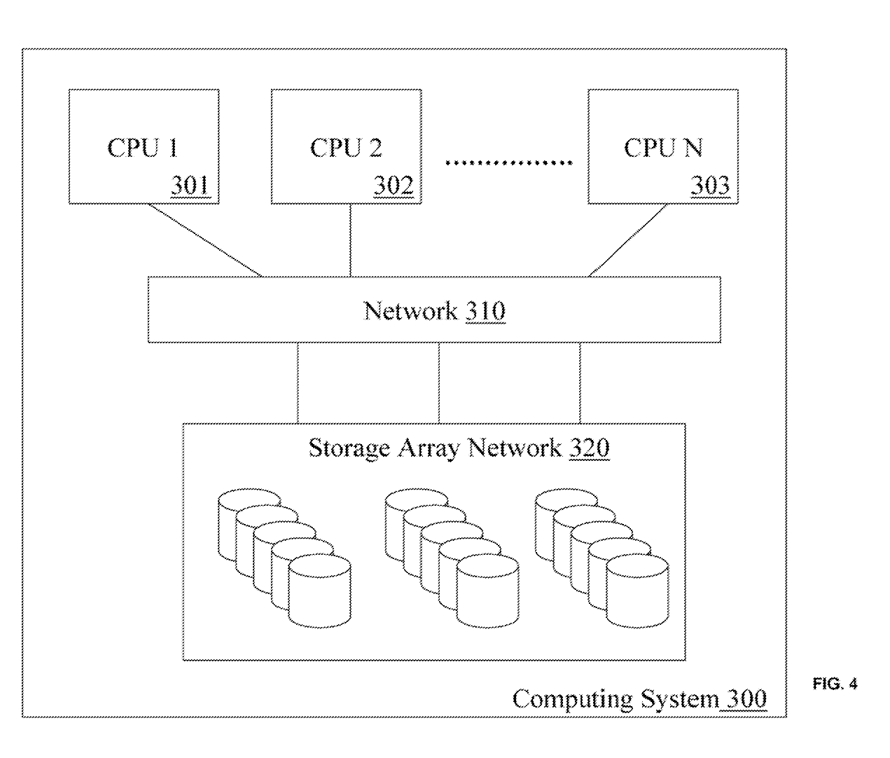

FIG. 4 is a diagram illustrating elements of an exemplary computing system 300, including central processing units (CPUs) 301, 302, 303, a network element 310 and a storage array network 320. The depicted configuration is typical of many currently available server-class computing systems. As described herein, aspects of the present invention are directed to systems and techniques for improving the performance of system 300 by constructing an analytical model of system 300. The analytical model is constructed by first obtaining system configuration information and runtime performance statistics of the different elements. The analytical model is provided with knowledge with respect to the particular set of applications running on system 300. The output of the analytical model includes performance numbers, as well as recommendations as to how to adjust the application parameters associated with the applications running on the computing system 300. The output of the analytical model can then be used to improve the future performance of the applications.

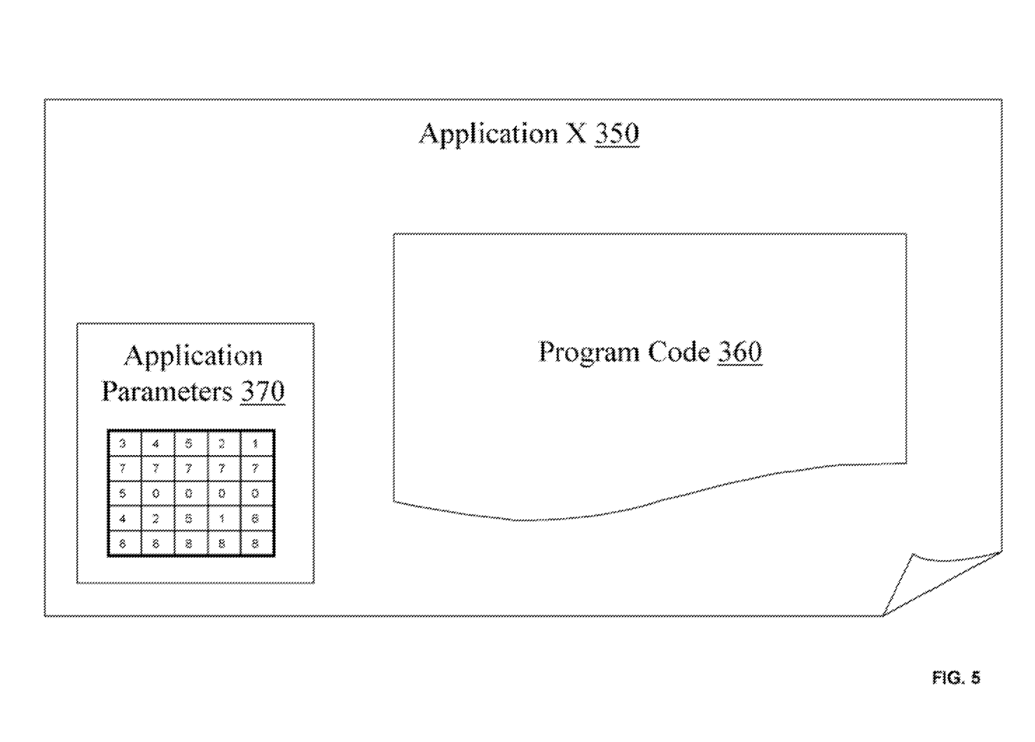

FIG. 5 shows a diagram of an application 350, which includes program code 360 and a set of application parameters 370 that are used to configure how the application 350 will run on computing system 300.

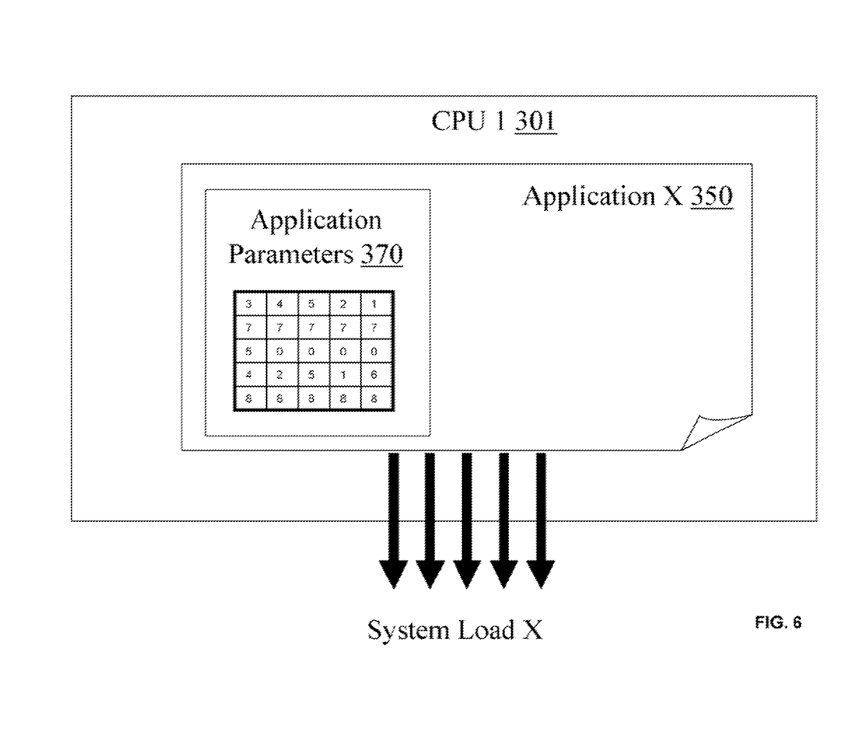

FIG. 6 shows a diagram of an application 350, which runs on CPU 1 301, which is supplied with a set of application parameters 370, generating a load on the system.

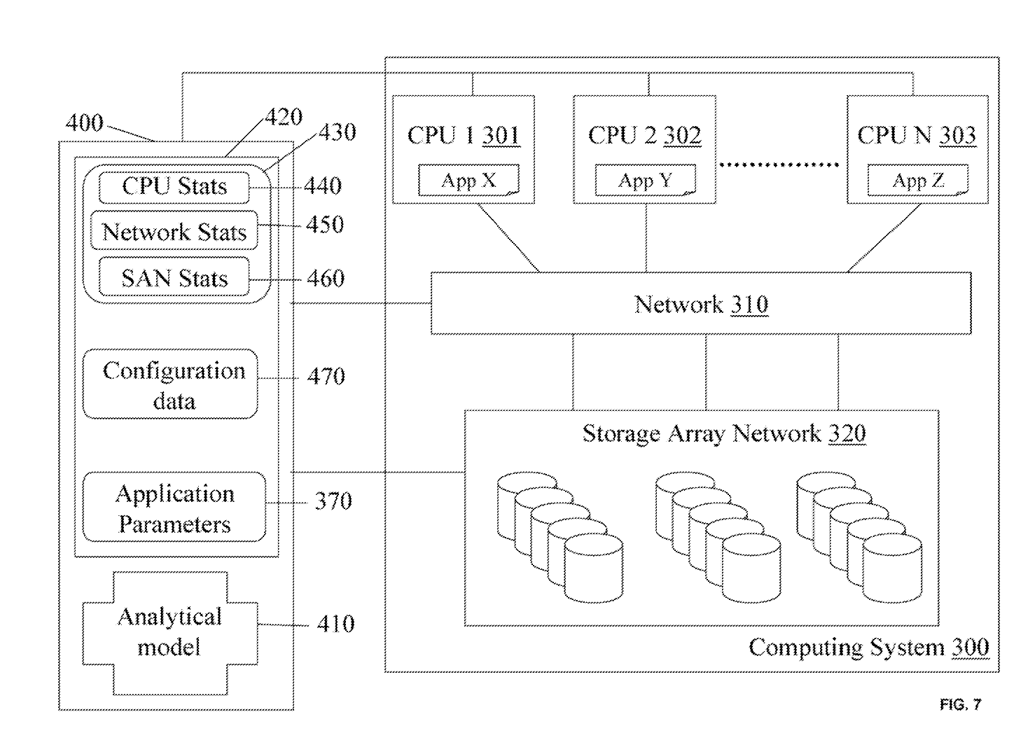

FIG. 7 shows a diagram illustrating computing system 300 and an information resource manager 400. The information resource manager 400 contains an analytical model 410 and maintains a database 420 of a number of computing system performance statistics 430, including CPU statistics 440, network statistics 450, and SAN statistics 460, computing system configuration data 470, and the set of application parameters 370 for the set of applications running on the computing system 370.

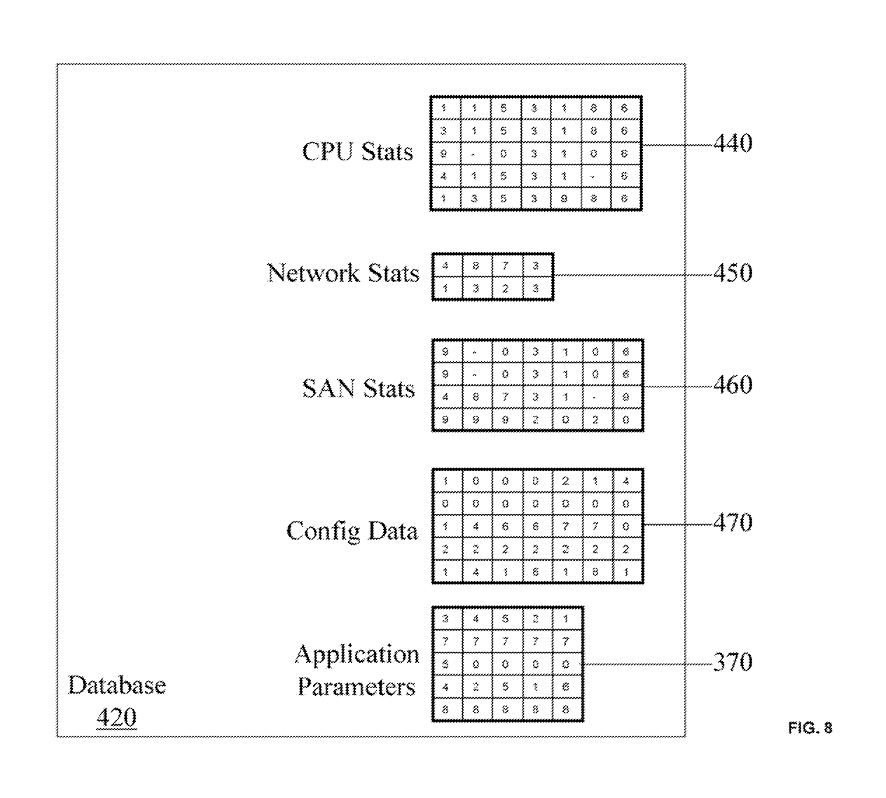

FIG. 8 shows the database 420 of CPU statistics 440, network statistics 450, SAN statistics 460, configuration data 470, and the application parameters 370 for the applications running on computing system 300.

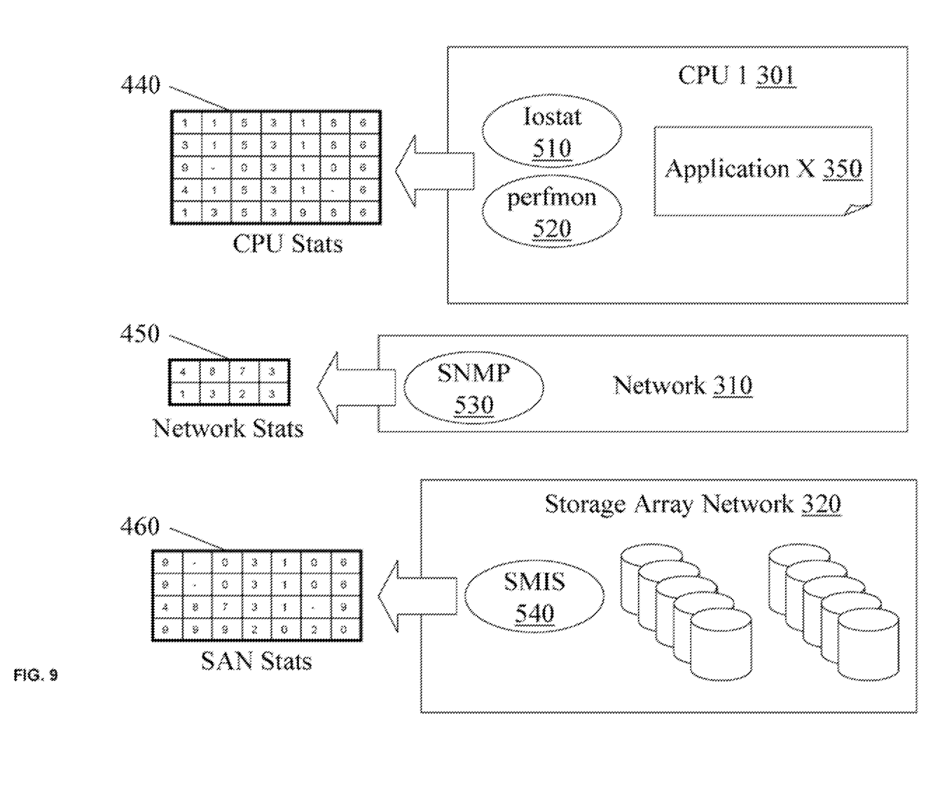

FIG. 9 shows a diagram illustrating an example of how performance statistics can be obtained from the computing system 300. CPU statistics 440 can be obtained from CPU 1 301 using standard software utilities such as iostat 510 and perfmon 520. Network statistics 450 can be obtained using the SNMP interface 530 that is provided on most network switch devices. SAN statistics 460 can be obtained via SMIS 540, which is provided on many SAN systems 120. The interfaces shown in FIG. 9 show one particular set of interfaces for obtaining performance statistics from the different elements, but does not preclude the information resource management unit 400 from accessing additional interfaces on the computing system that are available.

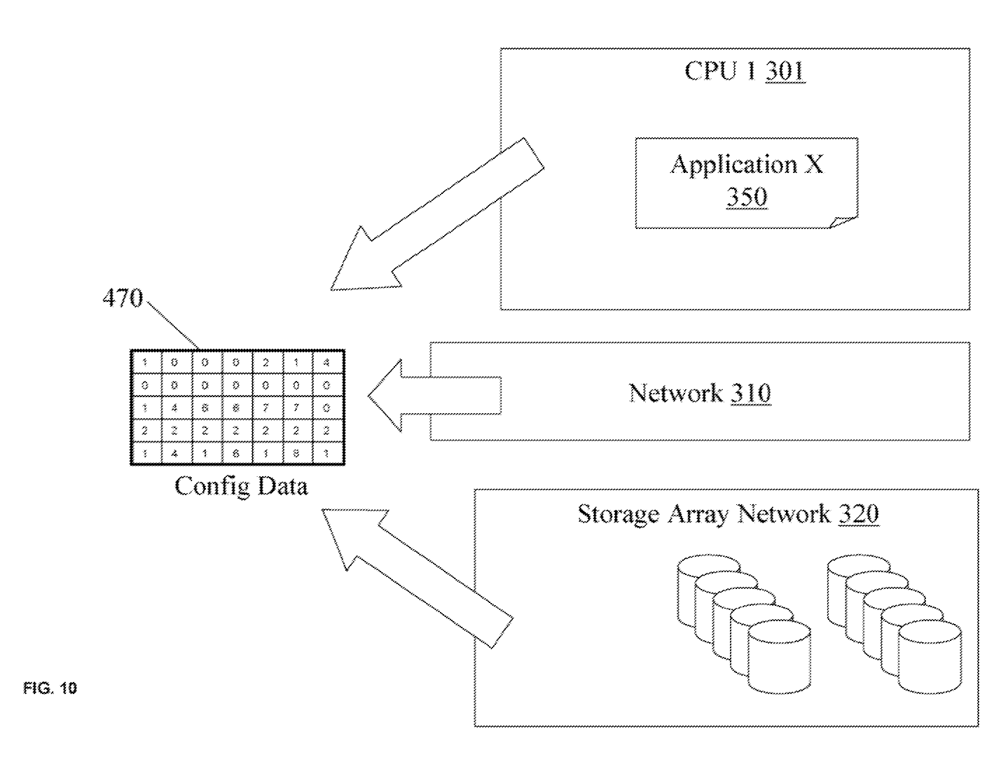

FIG. 10 shows how configuration data 410 is obtained from each element of the computing system 100. Each vendor of the different computing system elements 100 generally provides an interface to report this information.

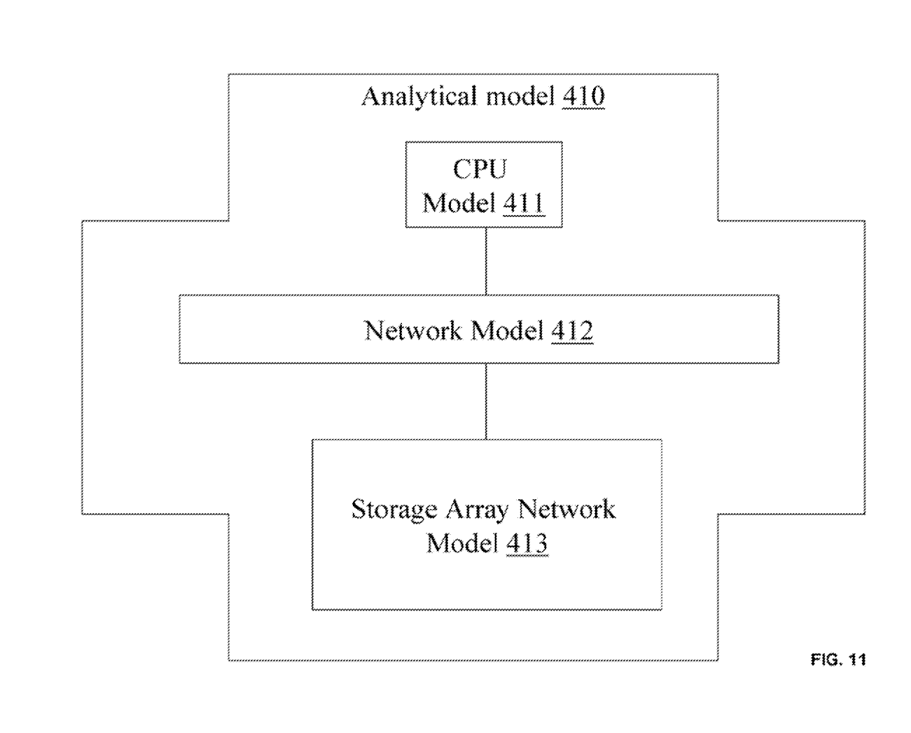

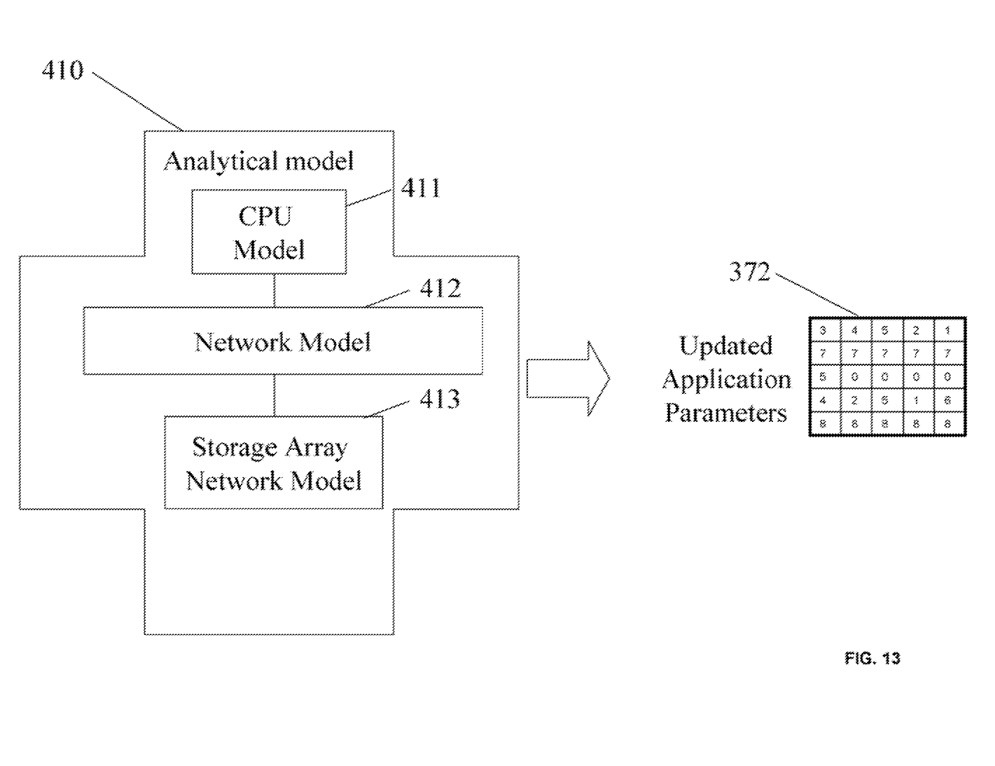

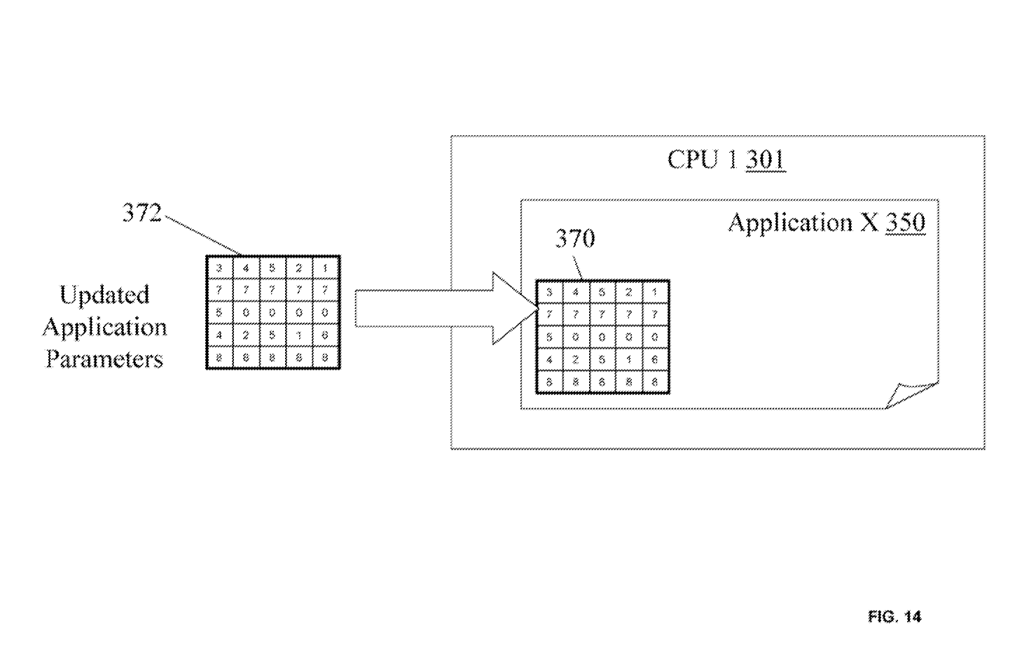

FIG. 11 shows a diagram of analytical model 410, which is part of the information resource management unit 400. The purpose of the analytical model 410 is to both generate performance indicators and produce an updated set of application parameters 372 (FIGS. 13-14) in order to improve the performance of applications running on the computing system 300.

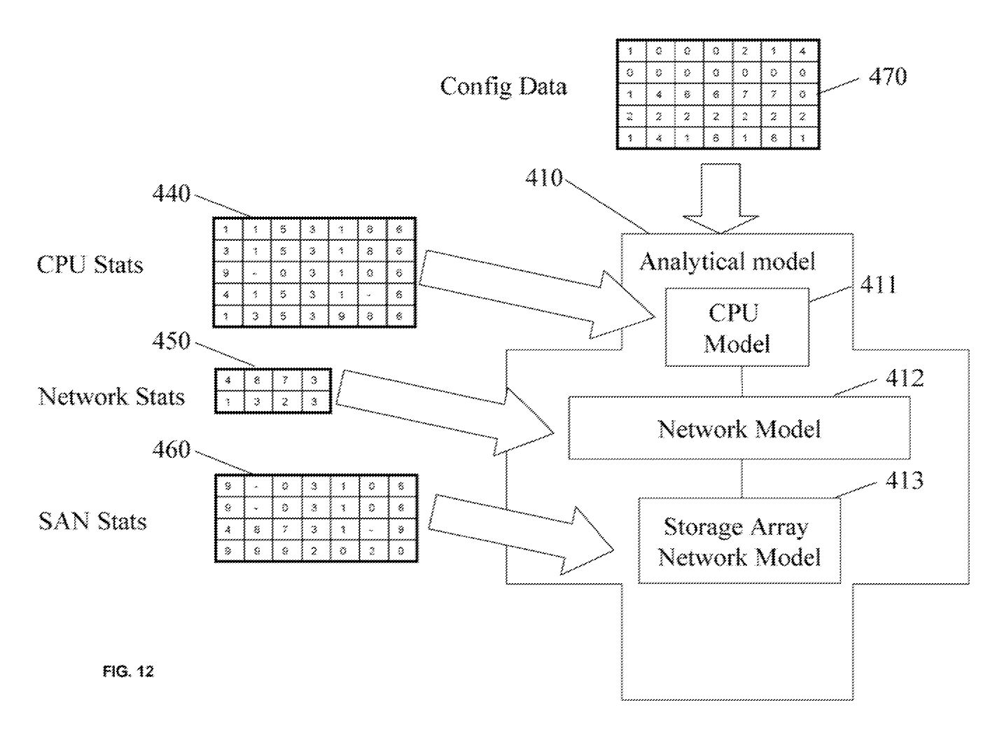

FIG. 12 shows how the configuration data 470, along with the CPU statistics 430, network statistics 430 and SAN statistics 440, are used to construct the analytical model 410. The analytical model contains models of the CPUs 411, network 412, and SAN 413, and may also contain additional computing system elements.

FIG. 13 shows how the analytical model 410 generates an updated set of application parameters 372. This new set of parameters will be fed to the computing system to reconfigure how the applications 350 running on the system use the elements of the computing system. The goal is to improve performance of the system.

FIG. 14 shows how the updated application parameters 372 are used to update the set of application parameters 370 used by the application 350. While FIG. 14 shows that the application is running on CPU 1 301, the application could run on any CPU on the system 302, 303, or on any other element in the system network 310 or SAN 320.

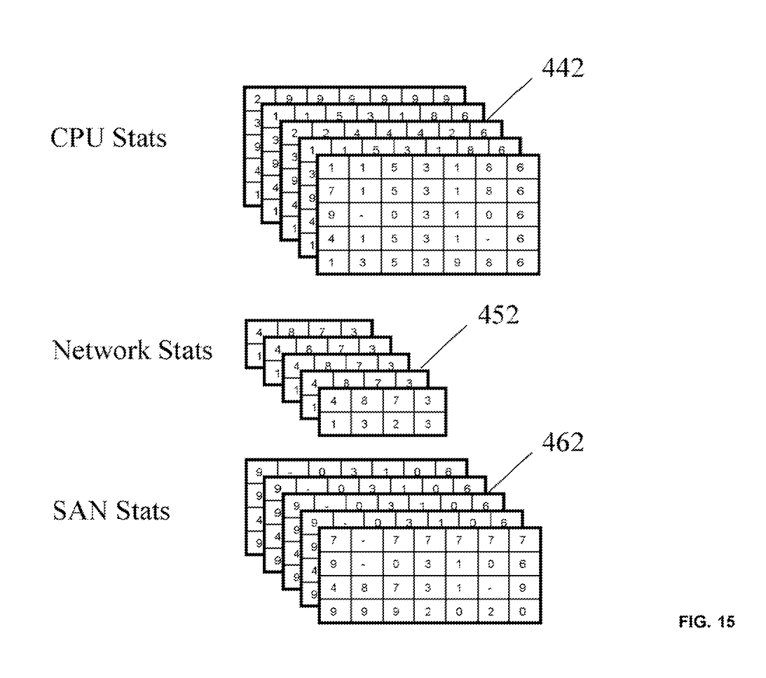

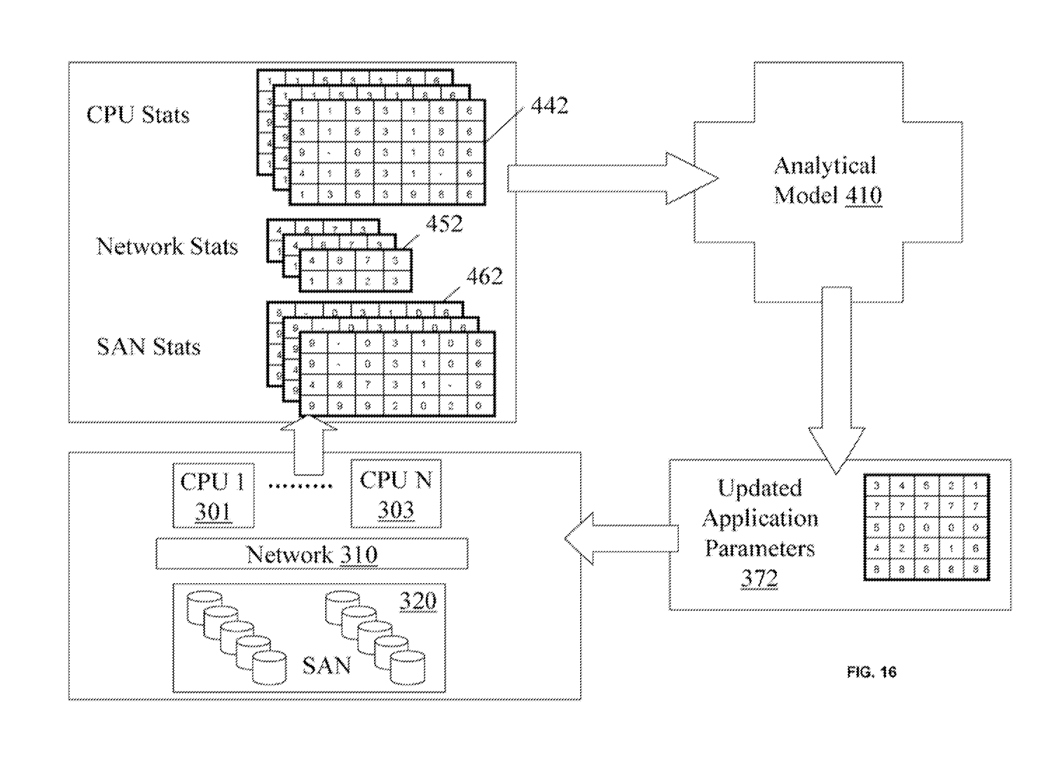

FIG. 15 shows that the information resource management unit can maintain a number of CPU 442, network 452 and SAN 462 statistics. These records are typically time-ordered and provide longer-term behavior of the system. This set of records can also represent performance statistics produced for multiple applications running on the computing system. This richer set of statistics can again to drive an analytical model 410, which then updates the application data 372 running on the computing system. This technique is further illustrated in FIG. 16.

### C. MANAGING APPLICATION SYSTEM LOAD—ADDITIONAL IMPLEMENTATION DETAILS AND EXAMPLES

The following discussion provides additional detail regarding one or more examples of implementations according to various aspects of the present invention. It will be understood by those skilled in the art that the following is presented solely by way of example, and the present invention can be practiced and implemented in different configurations and embodiments, without necessarily requiring the particular structures described below. The following discussion is organized into the following subsections:
C1. System Architecture
C2. The External Discovery Subsystem
C3. Discovery Engine

C1. System Architecture

The presently described architecture is generally referred to herein as Event Level Monitor (ELM). The ELM architecture supports the following ELM product features: (1) data center visibility; (2) hot spot detection; and (3) analysis.

In order to support these capabilities the ELM architecture provides the following features: configuration/topology discovery; statistics gathering; statistics calculations; application-specific storage topology and statistics; analysis; and alarm and event generation.

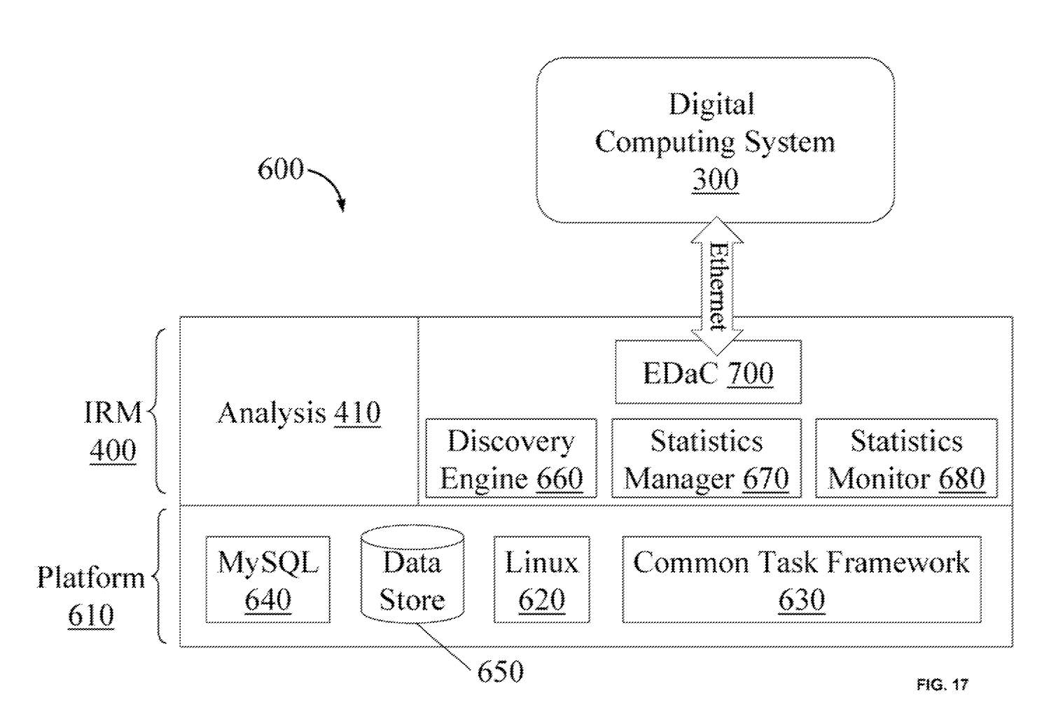

FIG. 17 shows a block diagram of the major components of an exemplary embodiment of the ELM architecture 600. Each of the depicted components is now described in turn.

Platform 610: The platform 610 provides the foundation upon which and the basic environment in which the IRM 400 runs.

Linux 620: The Linux OS 620 provides the low level functions for the platform.

Component Task Framework (CTF) 630: The Component Task Framework 630 provides a useful set of common primitives and services, messaging; events; memory management; logging and tracing; debug shell; timers; synchronization; data manipulation, including hash tables, lists, and the like.

MySQL 640: The repository of the system's data, the Data Store (DS) 650, is stored in a centralized database built on top of MySQL 640.

Data Store (DS) 650: The DS 650 contains the discovered elements, their relationships or topology, and their statistics.

Information Resource Manager (IRM) 400: The Information Resource Manager (IRM) 400, discussed above, is responsible for collecting all the information, topology and statistics, about the data center.

External Discovery and Collection (EDaC) 700: The External Discovery and Collection (EDaC) 700, described further below, component provides the system with its connection to the elements, such as servers and storage arrays, of the data center. It knows how to talk to each specific type of element, e.g. CLARiiON storage array, and discover its topology or gather statistics from it. Thus, it has separate modules, or collectors, for each specific array or server. There is a standard API for each type of element which is defined in XML and which every collector conforms to.

Discovery Engine 660: The Discovery Engine 660 drives the discovery of the topology of the data center elements, specifically servers and storage arrays. The user enters the servers and storage arrays that he wants discovered. The Discovery Engine 660 accesses the Data Store 650 to get the lists of servers, networks, and storage arrays the user has entered. For each one, the Discovery Engine 660 asks the EDaC 700 to get its topology. The EDaC 700 queries the elements and returns all the information discovered, e.g. disks for storage arrays. The Discovery Engine 660 then places this information in the Data Store 650 and makes the relationship connections between them. On the first discovery for a server, the Discovery Engine 660 also notifies the Statistics Manager 670 to begin collecting statistics from the server. In addition, the Discovery Engine 660 also periodically wakes up and “re-discovers” the elements of the digital computing system 300. This allows any topology changes to be discovered.

Statistics Manager 670: The Statistics Manager 670 drives the gathering of statistics from computer system elements, specifically servers. In the current product, statistics are only gathered from servers, although these statistics are used to derive statistics on other data center elements as well. The Statistics Manager 670 is notified by the Discovery Engine 660 when a new server has been discovered. It then adds the server to its collection list. Periodically it wakes up and runs through its collection list. For each server in the collection list, it asks the EDaC 700 to collect the statistics for it. Once the EDaC 700 has collected the statistics for a server it sends these to the Statistics Manager 670. The Statistics Manager 670 processes these statistics and inserts them into the Data Store 650. Some statistics are added to the Data Store 650 unmodified, some are added after some simple processing, such as averaging, and others are processed with more sophisticated algorithms which derive completely new statistics.

Statistics Monitor 680: New statistics are constantly being gathered and calculated. This means that a user can go back in time to see what was happening in the system. All statistics are stored in the Data Store (DS) 650. The stored statistics include calculated as well as gathered statistics. This makes them always immediately available for display.

The Statistics Monitor 680 monitors and manages statistics once they have been put into the Data Store 650 by the Statistics Manger 670. Inside the Statistics Monitor 680 are several daemons that periodically wake up to perform different tasks on the statistics in the Data Store 650. These tasks include: creating summary statistics, for instance rolling up collected statistics into hourly statistics; calculate moving averages of some statistics; compare some statistics against threshold values and generate events, which eventually generate alarms when thresholds are crossed.

There are different types of statistics calculated and analyzed. Some of these include the following:

Calculated Statistics: Calculated statistics are statistics that are created by performing calculations on gathered or other calculated statistics. The calculations can be as simple as a summation or as complicated as performing a non-linear curve fit. They are stored in the DS 650 in the same way and format as the statistics that are gathered.

Calculated Storage Statistics: It is important to note that all storage statistics are derived from the statistics gathered from Server LUNs. The discovered Server and Storage Array Topologies are then used to derive the statistics for the other storage objects: Server Volume, Storage Array LUN, ASG, and Sub-Group.

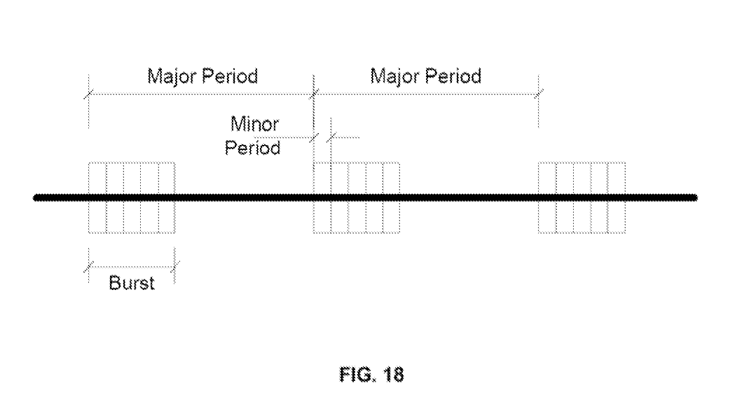

Collection and Calculation Frequencies: Statistics collection is done in a manner such that utilization can be calculated over a time when the system is statically stable. Statistically stable does not mean that the statistics are unchanging, but rather that the system is doing the same type of work, or set of work, over the period. Calculating utilization requires a series of samples. Thus, in order to calculate utilization on a statistically stable period a series of samples must be collected in a short period of time. However, constantly collecting statistics at a high frequency for a significant number of servers puts too high a burden on the system. The above requirements/restraints are met by collecting statistics in bursts, as shown in FIG. 18.

The parameters have the following meanings:

| | |
|---|---|
| Major Period | The time between bursts of samples. The range |
| | is 5 to 60 minutes. |
| Minor Period | The time between each sample of a burst. The |
| | range is 1 to 10 seconds. |
| Burst | The number of samples taken each major period |
| | at the minor period rate. The range is 1 to 50 |
| | samples. |

These parameters are variable on a per server basis. Thus it is possible to collect statistics on one server with a major period of 30 minutes, minor period of 10 seconds and a burst size of 10, while collecting statistics on another server with a major period of 15 minutes, minor period of 1 second and a burst size of 25. Statistics that are not used in calculating utilization are collected once at the major period frequency. Statistics collected in a burst are used immediately to calculate utilization. The result of the utilization calculation is saved in the DS and the raw data is discarded. Thus, statistics are inserted into the DS once per major period per server.

Server Statistics Calculation Frequency: All the statistics for a server: CPU, memory, LUNs and Volumes, are collected and calculated at the same time. This is done at the major sample rate for the server.

ApplicationStorageGroup/StorageGroup Statistics Calculation Frequency: A particular issue is the calculation period for ApplicationStorageGroups (ASGs) and StorageGroups (SGs). The statistics for ASGs and SGs are calculated from Server LUN statistics that could come from different servers. Most likely these Server LUN statistics are collected at different times and also at potentially different rates. This means that the ASG/SG statistics cannot be calculated at a Major Sample Period. They must be calculated at some slower rate, so that multiple samples from each Server LUN can be used.

Current Status Update Frequency: Many objects keep a current, historic and trend status. The current status is calculated relatively frequently, but slower than Major Sample rate.

Historic Status and Trend Update Frequency: The historic status and trend are longer term indicators and are thus calculated less frequently.

Summary Calculation Frequency: Summarization is a mechanism by which space is saved in the database. It operates under the theory that older data is less valuable and does not need to be viewed at the granularity as newer data.

Discovery Frequency: Discovery gathers relatively static data about the environment. As such, it does not need to run very often. However, this needs to be balanced with desire for any changes to appear quickly.

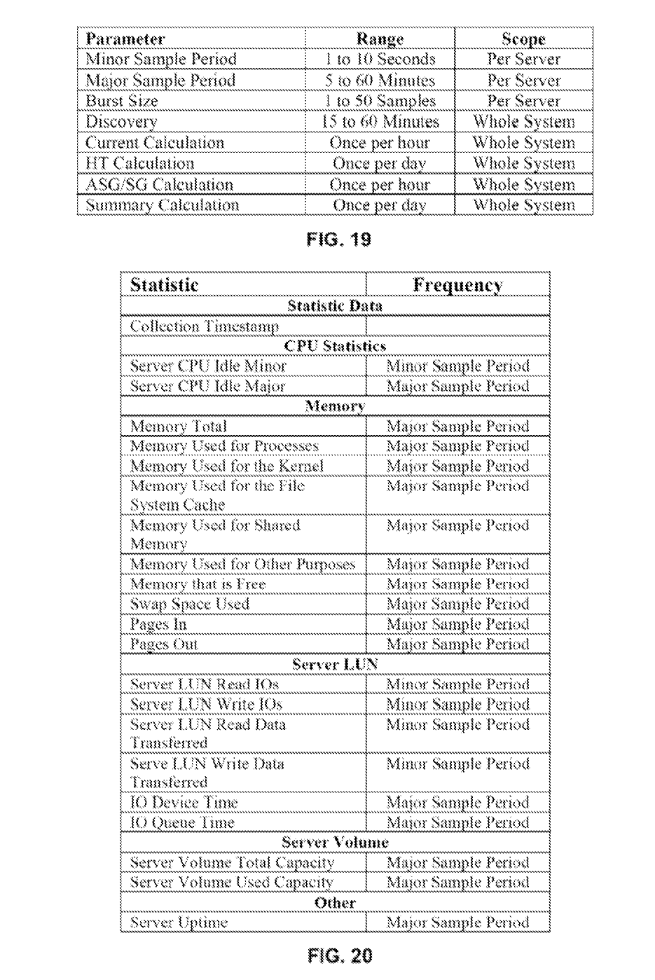

Summary of Collection and Calculation Frequencies: The table shown in FIG. 19 provides a summary of the collection and calculation frequencies. Note that all collection and calculation parameters should be parameterized so that they can be modified.

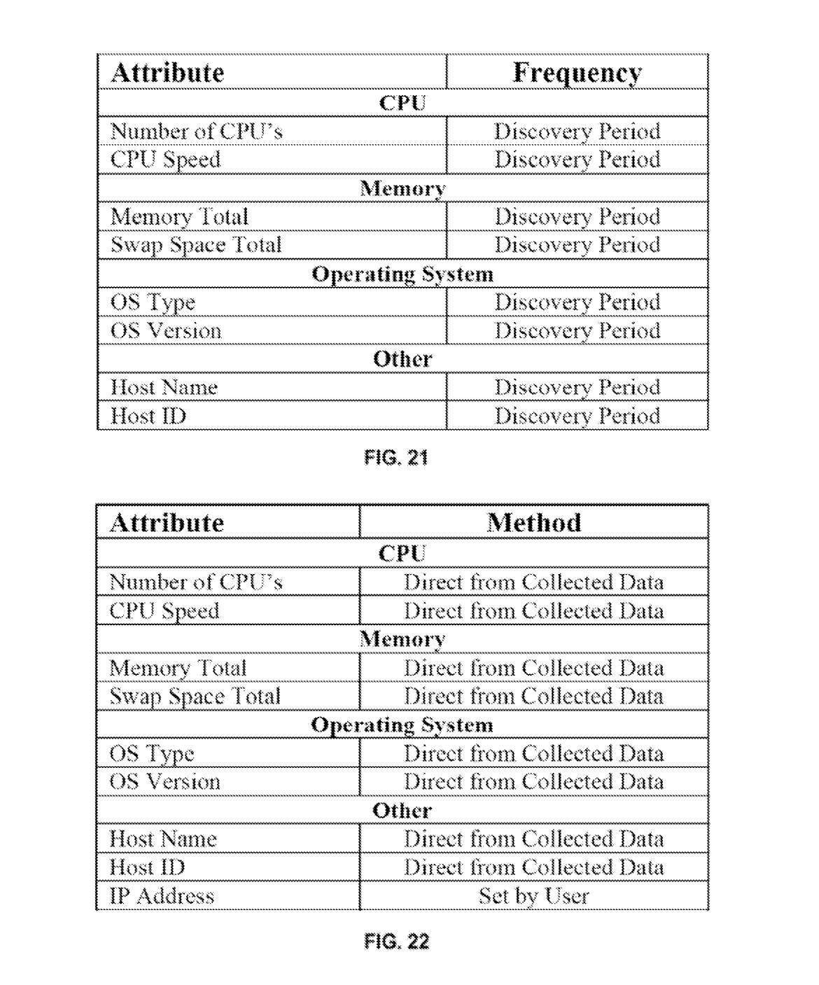

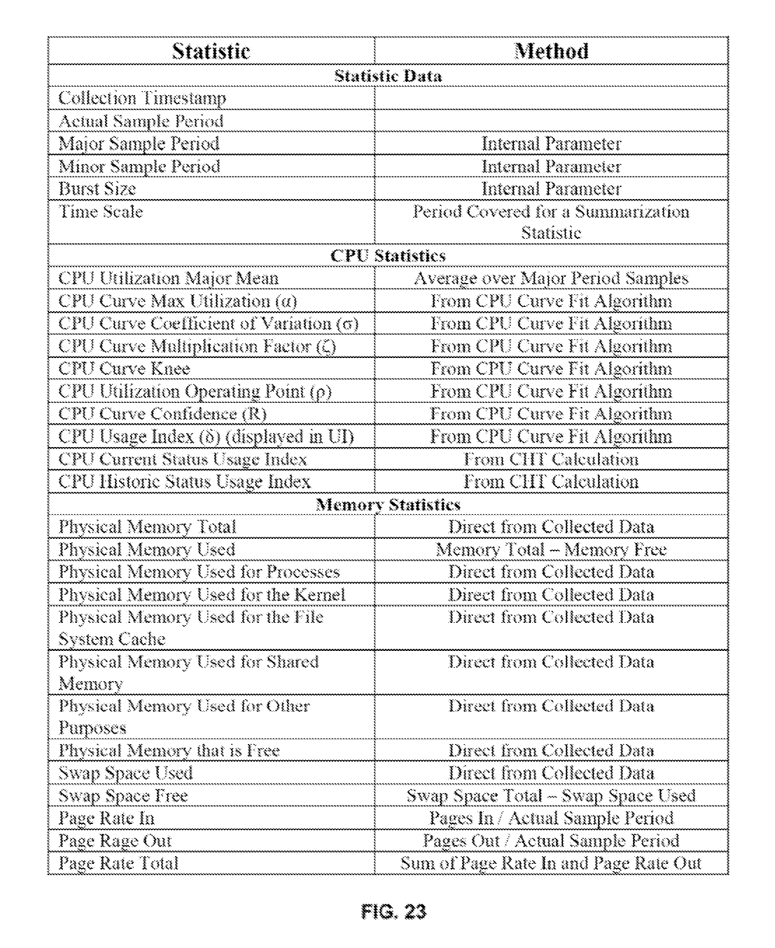

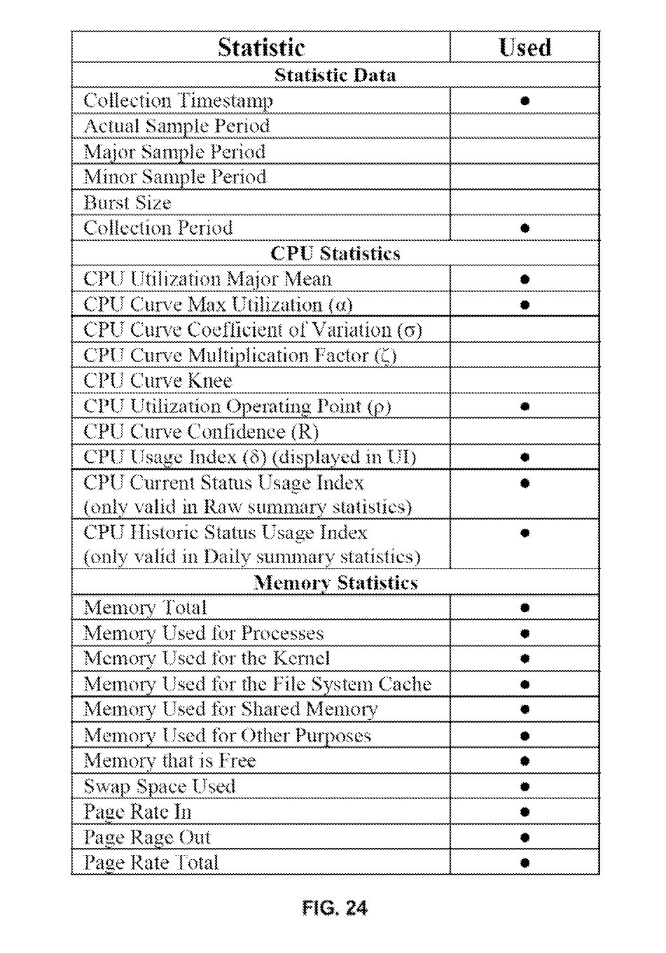

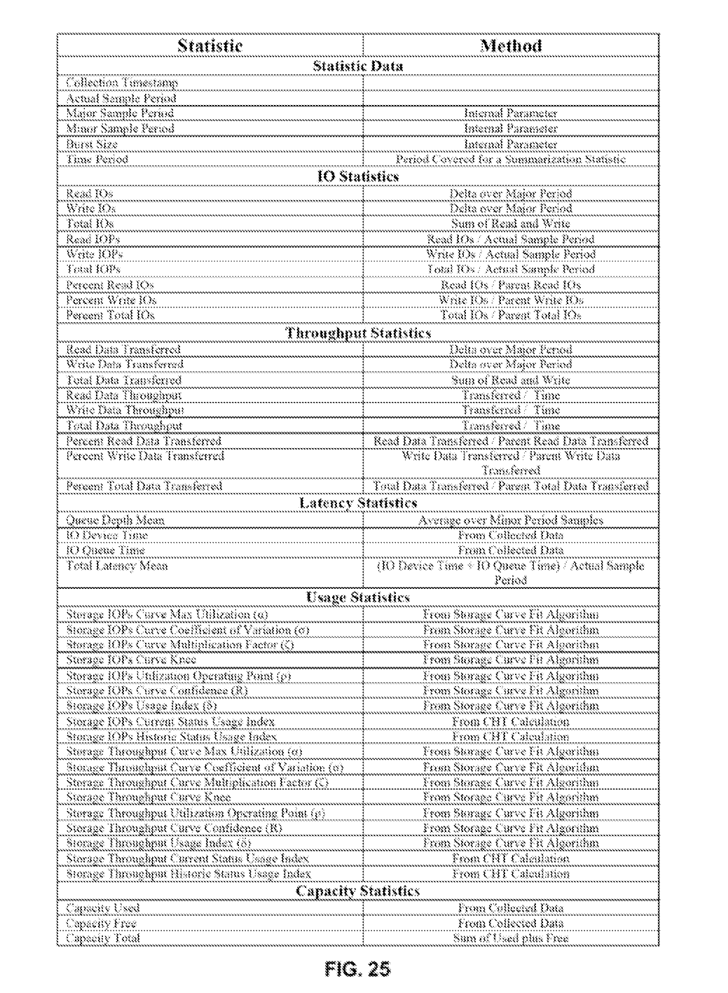

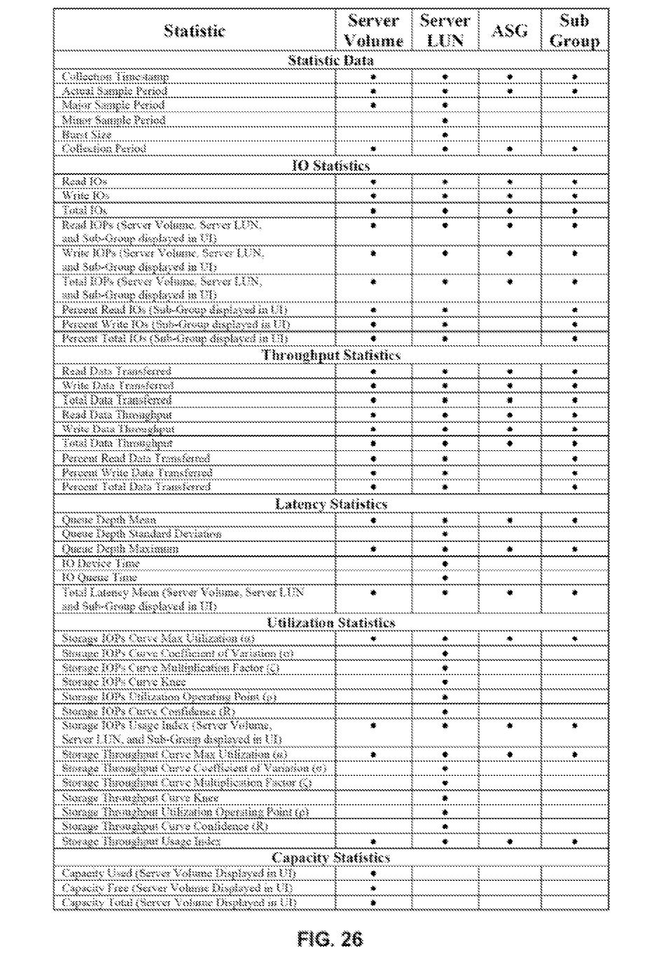

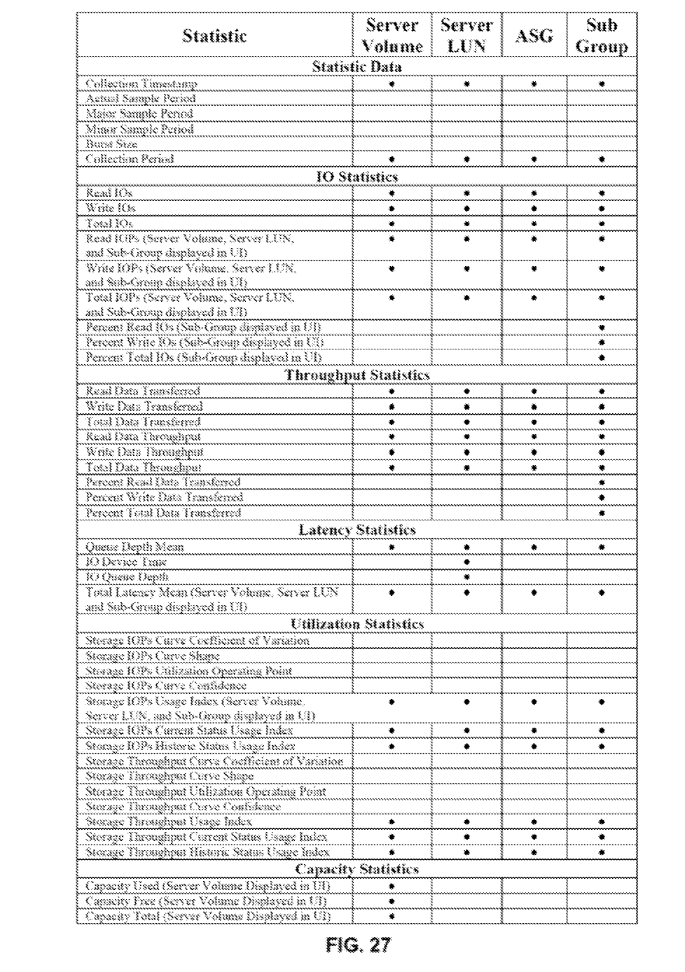

Statistics Summary: The tables shown in FIGS. 20-27 provide a summary of the statistics for the ELM system described herein.
FIG. 20—Server Statistics Collected Server statistics are gathered from the server. These are dynamic statistics that are gathered frequently at the Major Sample Period rate.
FIG. 21—Server Attributes Collected Server attributes are gathered from the server. These are relatively static parameters that are gathered infrequently at the Discovery rate.
FIG. 22—Server Attributes Stored Server attributes are gathered from the server. These are relatively static parameters that are gathered infrequently at the Discovery rate.
FIG. 23—Server Current Stored Statistics Server statistics are generated from the collected server statistics and then stored in the database. There should be one of these generated per Major Sample Period per server.
FIG. 24—Server Summary Statistics Summary server statistics are rollups of server statistics from a shorter time period to a longer time period. For instance, major period statistics can be summarized into daily or weekly statistics.
FIG. 25—Storage Statistics Stored There is a common storage statistic that is used to store statistics for a variety of storage objects. The frequency with which a storage statistic is generated depends on the object it is being generate for. Server Volumes—one per major sample period; Server LUNs—one per major sample period; Application Storage Groups—one per Application Storage Group/Storage Group calculation period; Sub-Groups—one per Application Storage Group/Storage Group calculation period.
FIG. 26—Storage Statistics Stored Not every statistic is valid for every object. The FIG. 26 table shows which statistics are valid for which objects.
FIG. 27—Summary Storage Statistics Stored Summary storage statistics are rollups of storage statistics from a shorter time period to a longer time period. For instance, major period statistics can be summarized into daily or weekly statistics.

Analysis: Analysis uses the data stored in the Data Store, primarily topology and statistics, to inform the user about what is happening to his system, or to make recommendations for the system. The analyses can either be implemented as a set of rules that are run by the rules engine against the data in the Data Store, or as an analytical model that be used to adjust application parameters. There are several different types of analysis that can be run. These include the following:

| | |
|---|---|
| Application Point In | Analyzes what is going on with an application's |
| Time Analysis | performance and its use of resources at a point in |
| | time. |
| Application Delta | Analyzes what has changed with an application's |
| Time Analysis | performance and its use of resources between two |
| | points in time. |
| Application Storage | Analyzes a path between the application and the |
| Group Analysis | storage at a point in time to determine whether it |
| | is a hot spot and whether there is application |
| | contention for it. |
| Storage Provisioning | Makes a recommendation as to where to provision |
| Recommendation | more physical storage for an application. |
| Application | Make modifications to the application parameters. |
| Recommendations | |

In addition to the foregoing, those skilled in the art will understand that various APIs (Application Programming Interfaces), constructed in accordance with known API practice, may be provided at various points and layers to supply interfaces as desired by system designers, administrators or others.

C2. External Discovery and Collection Service

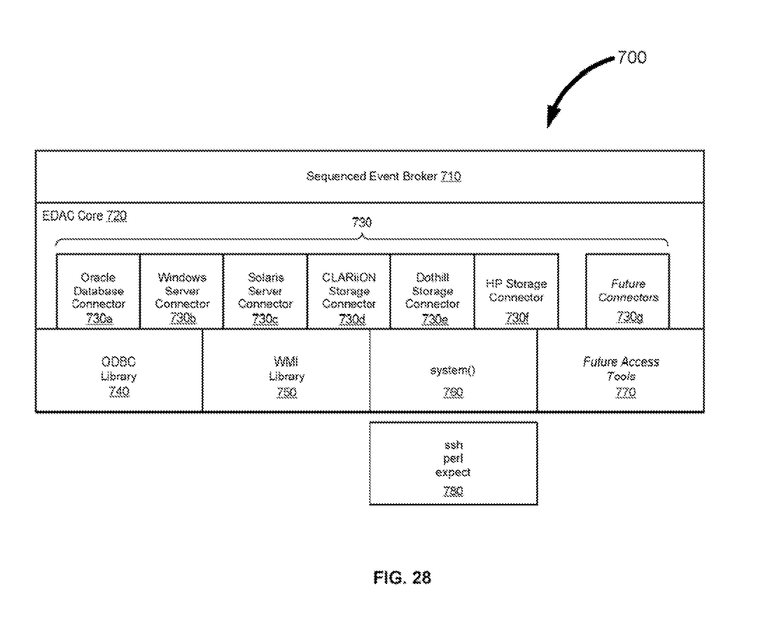

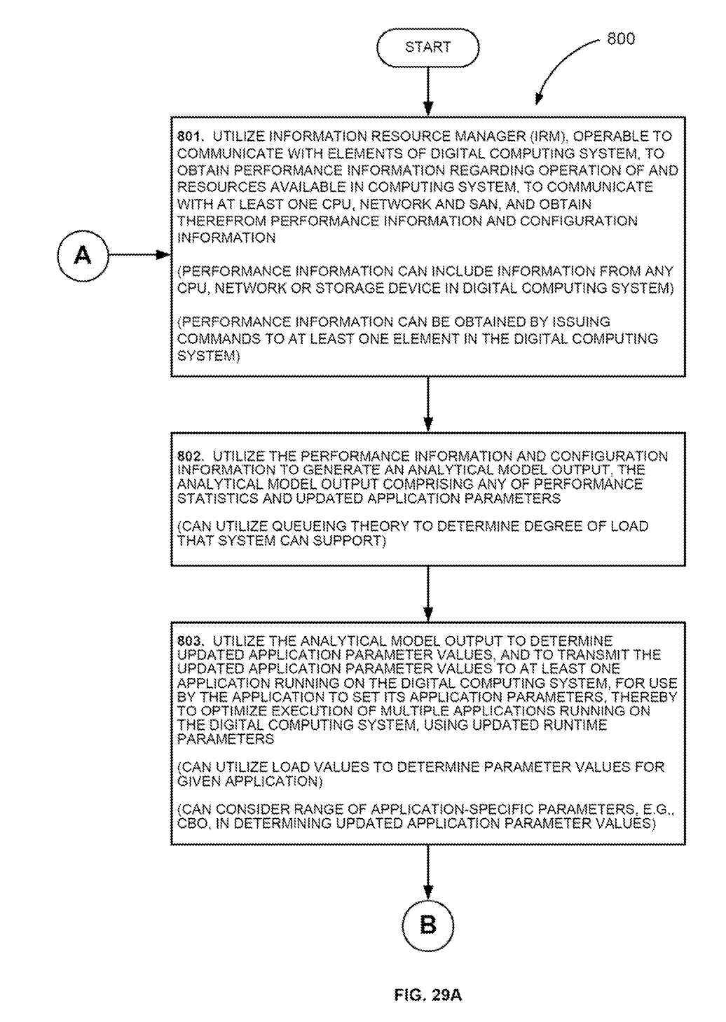

There is now described in greater detail the above-mentioned External Discovery and Collection (EDaC) service, which provides access to all configuration and statistics for resources external to the appliance. The EDaC service is responsible for dispatching requests to any external resource. FIG. 28 is a diagram illustrating the variety of connectors contained in an exemplary embodiment of the EDaC service 700. Each connector 730 provides access to a specific resource.

The list of responsibilities includes the following: (1) listen for statistics request events, and forward them to the appropriate connectors; (2) listen for discovery request events, and forward them to the appropriate connectors; and (3) perform discovery requests on all connectors on some schedule, and generate discovery events. According to a further aspect of the invention, the functionality of item (3) may be moved to the Information Resource Manager (IRM).

There are two parts to the discovery process: (1) “finding” a device, and (2) figuring out the mostly static configuration for the device. The discovery algorithms must be robust enough to handle thousands of devices. A full discovery process may take hours. With respect to configuration, the following data is needed in the object model to accomplish discovery and collection:

Server: IP address, login/password; SSH/telnet, if Solaris; polling interval; and persistent connection.

StorageArray: management server; login/password; path to CLI; polling interval; persistent connection.

Application: IP address, login/password; service name, port; polling interval; persistent connection.

Various well-known data access tools can be utilized in conjunction with this aspect of the invention, and multiple access methods, including configurable access methods, may be employed. These could include telnet access to a server, database data access via ODBC (which may utilize ODBC libraries commercially available from DataDirect Technologies of Bedford, Mass.), SSH techniques, and other conventional techniques.

Sequenced Event Broker 710 provides an interface to the EDaC Core 720, which contains the described Connectors 730.

The Oracle Database Connector 730a is responsible for collecting the database configuration and database statistics. Oracle Database Connector 730a uses the ODBC library 740.

The Windows and Solaris Server Connectors 730b and 730c are responsible for collecting OS-level data, such as memory utilization, and Volume/LUN mappings and statistics. In order to calculate Volume/LUN mappings, it may be necessary to understand both the installed volume manager as well as the multipathing product. Even if it is not necessary to understand the specifics of each, i.e. striping characteristics or path info, it is likely that info will be needed from each product just to calculate which LUNs are associated with the volume. Specific products may be picked to target for Elm. The Solaris Server Connector 730c uses SSH. The volume managers for Solaris are Veritas and the native one. The Windows Server Connector 730b uses the WMI library 750. The volume manager for Windows is the native one, which is Veritas.

The Storage Connectors 730d, 730e and 730f are responsible for collecting LUN utilization, performance, and mapping to raid sets/disks, and other data generally represented by box 760. No array performance statistics are needed for ELM.

With respect to the CLARiiON Storage Connector 730d, NaviCLI is a rich CLI interface to the CLARiiON. It can return data in xml. Performance statistics can be enabled on the CLARiiON and retrieved through the CLI. It would also be possible to install the CLI on the ASC. It is more likely that the CLI would be accessed from one of the customer servers through SSH 780. Some data is also available by telnet directly to the CLARiiON.

With respect to the Dothill Storage Connector 730e, the Dothill also has a host-based CLI. It can return data in xml. The Dothill provides no access to performance statistics. The access issues are the same as with the CLARiiON CLI. Some data is also available by telnet directly to the Dothill.

A suitable HP Storage Connector 730f is also provided.

As represented by box 730g, the presently described system may be modified and expanded to include the following elements: CIM/WBEM/SMI-S access; SNMP access; fabric connectors; external SRM connector; remote proxies/agents; events to change configuration. Further, one Windows agent may serve as gateway to “the Windows world,” and would integrate with WMI and ODBC more seamlessly. These future access tools are represented by box 770.

C3. Discovery Engine

The above-mentioned Discovery Engine is now described in greater detail. The Discovery Engine (DE) resides in the Information Resource Manager (IRM). It is responsible for initiating periodic topology discovery of servers and storage arrays that have been entered into the Data Store (DS) by the user. It does this in conjunction with the External Discovery and Collection (EDaC) module, described above.

The DE is built around a main loop that processes messages from its message queue. These messages include:

| | |
|---|---|
| Discovery Timer | This event initiates a full discovery process. |
| Event | |
| Discovery | These are the Discover Storage Array Topology |
| Complete Events | and Discover Server Topology events that were |
| | originally sent to the EDaC by the DE, and are |
| | now being returned by the EDaC after the EDaC |
| | has generated all the discovery events for the |
| | server or storage array. These events indicate that |
| | the topology discovery has been completed for the |
| | server or storage array. |
| Object Discovery | The EDaC generates a discovery event for each |
| Events | object it discovers in the process of determining |
| | the topology of a server or storage array. For |
| | example, the EDaC generates Server, Server FC |
| | Port, Server Volume, and Server LUN discovery |
| | events when it is requested to determine the |
| | topology of a server. |

The main loop can simply wait on the message queue for the next message to process.

Discovery Timer Event: The DE uses the Component Task Framework (CTF) to set a discovery interval timer. When the timer has elapsed, the CTF generates a message and delivers it to the DE's message queue. This tells the DE that it is time to begin a discovery process.

The Discovery Timer event causes the DE to launch N initial Discover Server Topology or Discovery Storage Array Topology events in parallel. N is an arbitrary number. Until there are no more servers or storage arrays to discover topology on, there will always be N outstanding discover topology events.

Server or Storage Array Discovery Complete Event: A Server or Storage Array Discovery Complete event is actually a Discover Server Topology or Discover Storage Array Topology event that has been returned to DE once the EDaC has completed the discovery on that object.

Discovery Complete Event Processing: The processing steps are as follows:

1. The DE queries the DS to find out if any of the existing record, e.g. a server LUN that was not discovered during the objects topology discovery. It does this by creating a query for all records whose discovery timestamp is not the same as that of the current record.

2. For each record whose timestamp does not match, an lost event, e.g. Server Volume Lost event, is generated and sent.

3. If there are more servers or storage arrays to be discovered, then the next one is retrieved from the DS and a Discover Topology event is sent for it to the EDaC.

4. If there are no more servers or storage arrays to discover, then the discovery is complete and the discovery interval timer is restarted.

Object Discovery Event: On receipt of a Discover Topology event the EDaC queries the server or storage array for its topology. The topology consists of a set of records. The EDaC generates a set of discovery events for the current event. It is important that the discovery events occur in a certain order:

Server Topology Discovery Events: Server Discovery Event; Server FC Port Discovery Event(s); Server Volume Discovery Event(s); Server LUN Discovery Event(s).

Storage Array Topology Discovery Events: Storage Array Discovery Event; Storage Array FC Port Discovery Event(s); Storage Array Disk Discovery Event(s); Storage Array LUN Discovery Event(s).

Included in each discovery event is a timestamp for the discovery. The timestamp is inserted by the EDaC. Each discovery event for a particular storage array or server has the same timestamp value.

Discovery Processing: The processing steps are as follows:

1. The DE queries the Data Store to determine if the record already exists.

2. If the record already exists, then the records relationships are verified and the discovery timestamp is updated.

3. If the record does not exist in the DS, then it is created along with its relationships to other records. Thus, processing at this step is particular to the record being discovered.

4. A “record discovered” event is created and logged.

### D. MANAGING APPLICATION SYSTEM LOAD—GENERAL METHOD

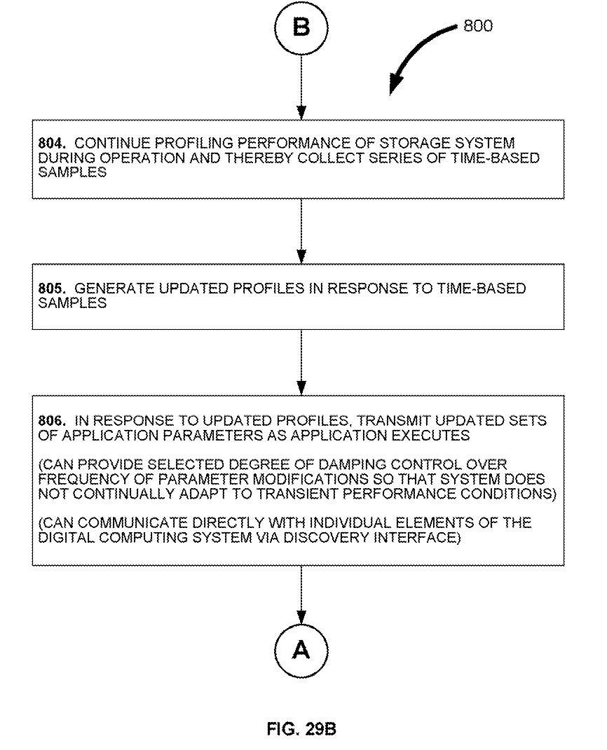

FIG. 29A is a flowchart of a general method 800 for optimizing execution of multiple applications running on the digital computing system. The method may advantageously be practiced in a networked digital computing system comprising at least one central processing unit (CPU), a network operable to enable the CPU to communication with other elements of the digital computing system, and a storage area network (SAN) comprising at least one storage device and operable to communicate with the at least one CPU. The computing system is operable to run at least one application program, the at least one application program having application parameters adjustable to control execution of the application program.

An exemplary method in accordance with the invention is illustrated in boxes 801-803:

Box 801: utilizing an Information Resource Manager (IRM), operable to communicate with elements of the digital computing system to obtain performance information regarding operation of and resources available in the computing system, to communicate with the at least one CPU, network and SAN and obtain therefrom performance information and configuration information. As noted elsewhere in this document, performance and configuration information can be from any CPU, network or storage device in the digital computing system. Information can be obtained by issuing I/O or other commands to at least one element of the digital computing system. The IRM can be a discrete module in the digital computing system, or implemented as a module in a computing system subsystem or storage network fabric subsystem in the SAN.

Box 802: utilizing the performance information and configuration information to generate an analytical model output, the analytical model output comprising any of performance statistics and updated application parameters. As noted elsewhere in this document, the invention can utilize queuing theory to determine a degree of load the storage system or subsystem can support.

Box 803: utilizing the analytical model output to determine updated application parameter values, and to transmit the updated application parameter values to at least one application running on the digital computing system, for use by the application to set its application parameters, thereby to optimize execution of multiple applications running on the digital computing system, using updated runtime parameters. As noted elsewhere in this document, the method can utilize load values, e.g., the load values determined using queuing theory, to determine parameter values for a given application. The method can also involve the consideration of a range of application-specific parameters, e.g., Cost-Based Optimization (CBO) parameters, in determining updated application parameter values.

FIG. 29B shows how the method 800 of FIG. 29A can continue to run, iteratively or otherwise, including by continuing to profile the performance of the storage system during operation, thereby collecting a series of time-based samples (804), generating updated profiles in response to the time-based samples (805), and in response to the updated profiles, transmitting updated sets of application parameters as a given application executes (806). As discussed elsewhere in this document, the method can include providing a selected degree of damping control over the frequency of application parameter updates, so that the system does not continually adapt to performance transients in performance conditions. The method can also include communicating directly with individual elements of the digital computing system via a discovery interface. (An exemplary correspondence between FIG. 29B and FIG. 29A is indicated via points “A” and “B” in the respective drawings.)

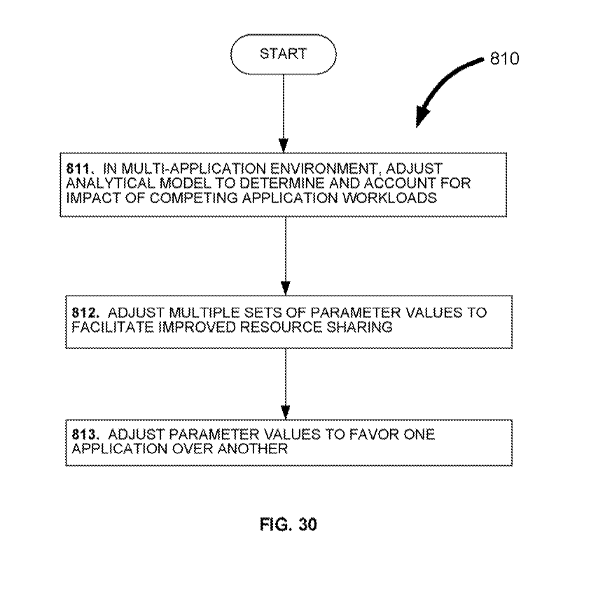

FIG. 30 shows how, in accordance with discussion elsewhere in this document, a method 810 according to the invention can further be implemented in an environment in which multiple applications are sharing network, storage or other resources, including by adjusting the analytical model to determine and account for the impact of competing application workloads (811), adjusting multiple sets of parameter values to facilitate improved resource sharing (812), and adjusting parameter values to favor one application, or its I/O requests or other aspects, over another application, or its I/O requests or other aspects, if desired.

### E. MULTI-LEVEL MAPPING OF APPLICATION SYSTEM STORAGE RESOURCES

Having described above one or more digital storage environments like those discussed in U.S. patent application Ser. No. 11/773,825 (AKR-110-US), of which this application is a Continuation-in-Part, we next proceed to describe aspects, embodiments and examples of the present invention in greater detail. Those skilled in the art will appreciate that the digital processing, computing or storage environments described in Ser. No. 11/773,825 (AKR-110-US) are just some of the examples of processing environments in which the present invention may be practiced, and will also appreciate that the present invention can be practiced in environments other than those described above and in Ser. No. 11/773,825 (AKR-110-US).

More particularly, aspects of the present invention provide methods, systems, apparatus and computer program code (software) products operable to effectively map system resources to applications, as well as improved storage platforms and architectures utilizing such methods and systems. The basis for this mapping is the definition of an Application Resource Group (ARG), which provides complete information about the servers, bus adapters, volumes, Logical Unit Numbers (LUNs), network switches, disk controllers, and disks associated with an application.

The present aspect of the invention is described with respect to a Storage Area Network (SAN) infrastructure architecture. However, it will be appreciated that aspects of the described systems and techniques may be practiced in other computing environments.

A storage area network (SAN) is an architecture that allows the attachment of remote computer storage devices, such as arrays of disk drives, to host servers in such a way that, to the operating system, the devices appear as locally attached.

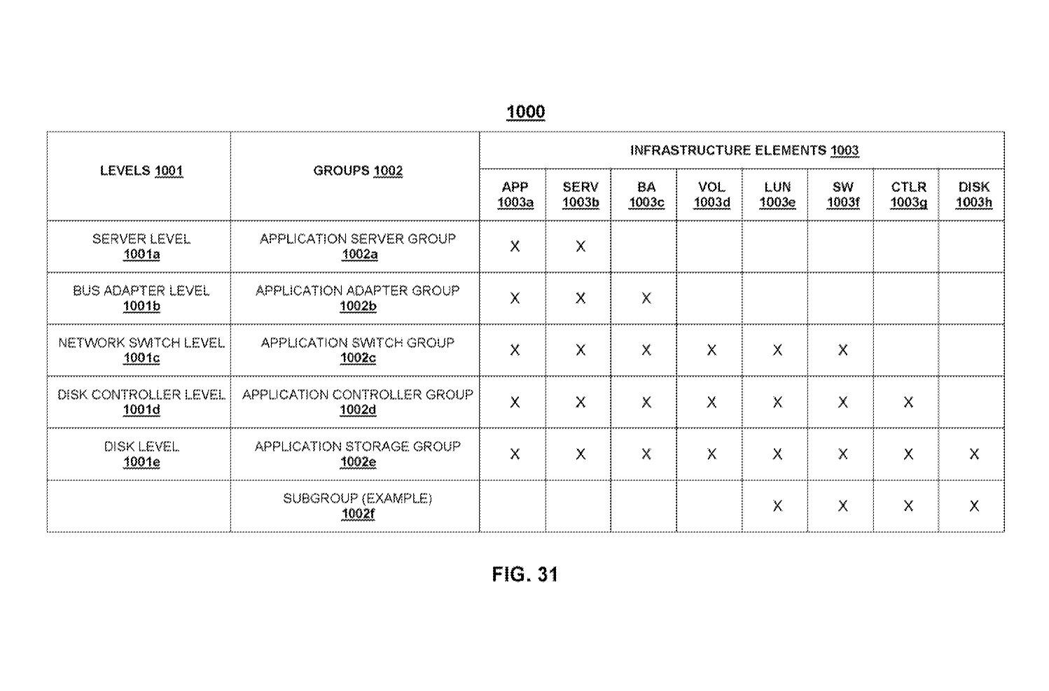

FIG. 31 is a table 1000 illustrating an exemplary mapping of a SAN infrastructure at a number of different levels. The first table column 1001 lists the following defined levels:
1001a—Server Level
1001b—Bus Adapter Level
1001c—Network Switch Level
1001d—Disk Controller Level
1001e—Disk Level

The second table column 1002 lists the following defined groups, corresponding to each of the defined levels:
1002a—Application Server Group (ASerG), corresponding to the Server Level;
1002b—Application Adapter Group (AAG), corresponding to the Bus Adapter Level;
1002c—Application Switch Group (ASwG), corresponding to the Network Switch Level;
1002d—Application Controller Group (ACG), corresponding to the Disk Controller Level; and
1002e—Application Storage Group (ASG), corresponding to the Disk Level.

As shown in table column 1003, each level 1001a-e and group 1002a-e corresponds to a subset of one or more of each of the elements of an exemplary infrastructure architecture:
1003a—Application (APP)
1003b—Server (SERV)
1003c—Bus Adapter (BA)
1003d—Volume (VOL)
1003e—Logical Unit Number (LUN)
1003f-Switch (SW)
1003g—Controller (CTLR)
1003h—Disk Array (DISK)

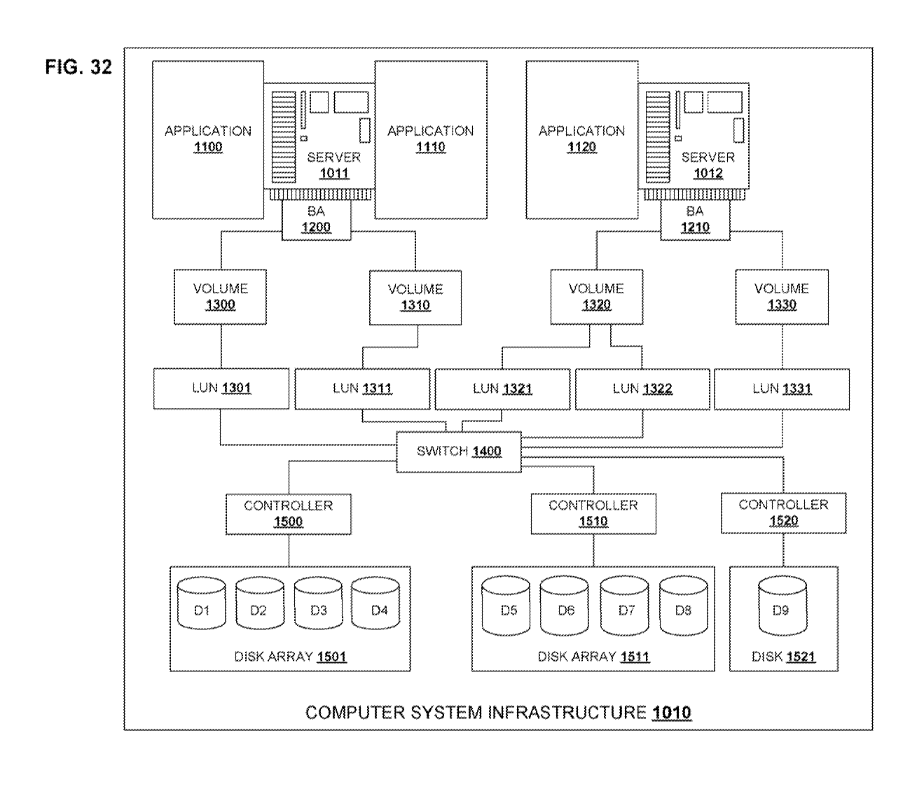

Generally speaking, each group 1002a-e includes the named element, and all “upstream” elements up to the Application 1003a. Thus, for example, the Application Switch Group (ASwG) includes a Switch (SW) and the elements upstream of the Switch, i.e.: Logical Unit Number (LUN), Volume (VOL), Bus Adapter (BA), Server (SERV), and Application (APP). The selection of particular infrastructure elements for each group is illustrated in FIGS. 32-37, discussed below.

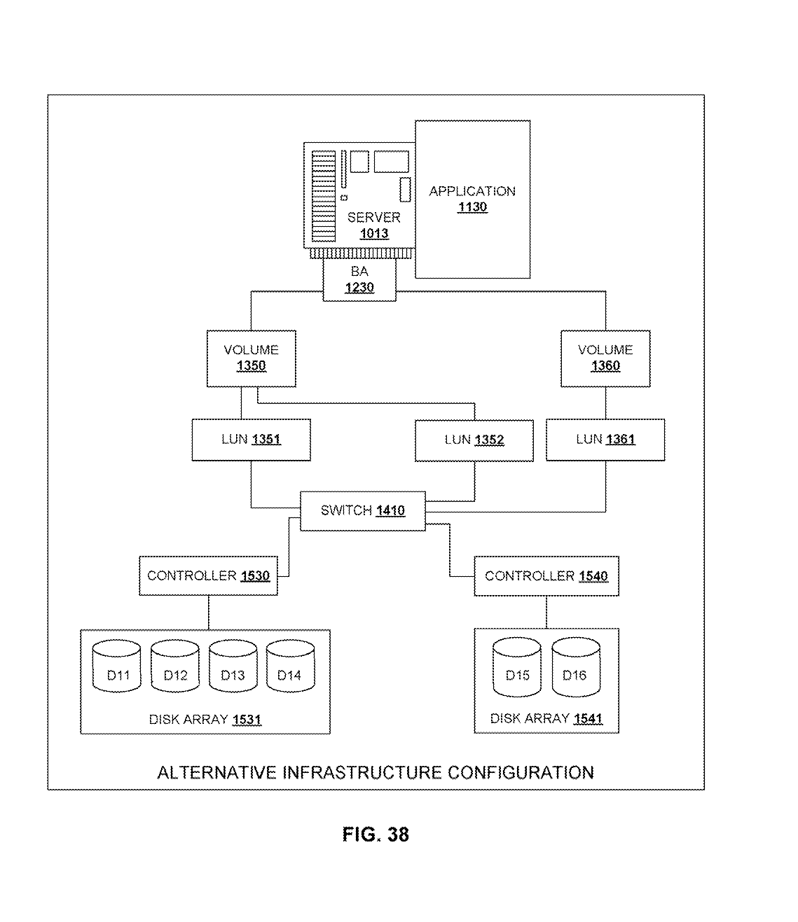

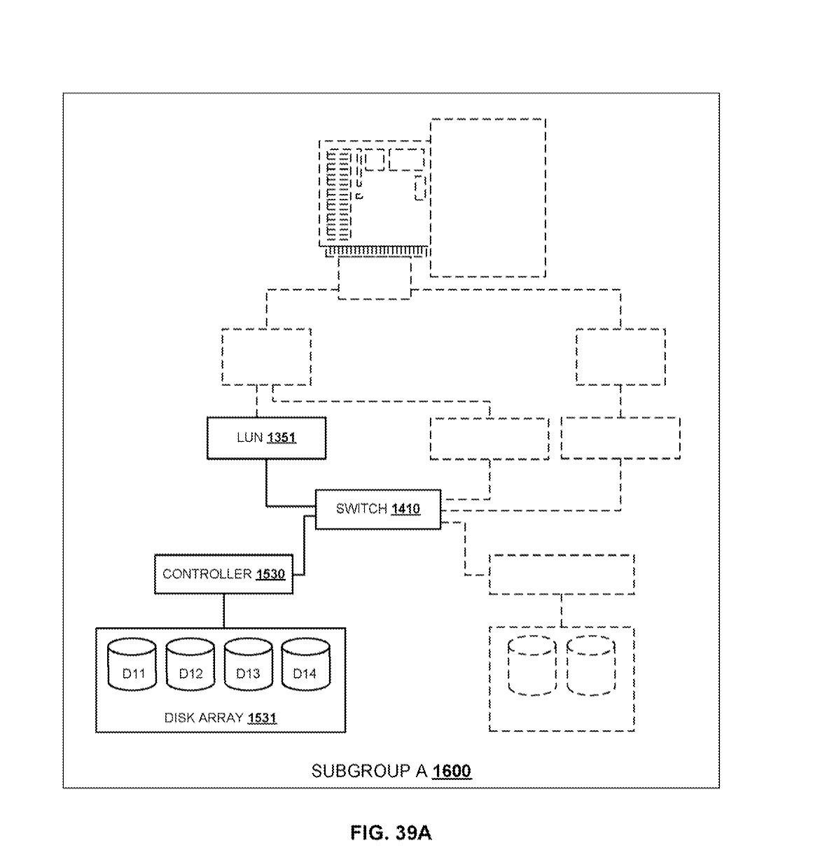

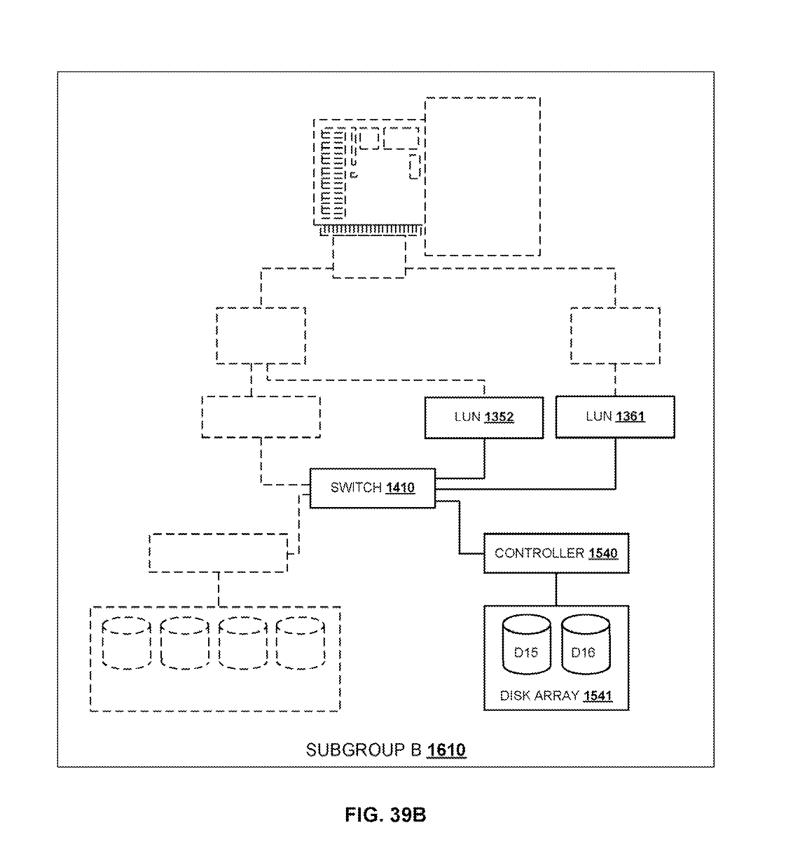

Further, the presently described aspect of the invention further provides for the definition of Subgroups 1002f. In table 1000, the exemplary subgroup 1002 is defined to provide more detailed information about individual LUNs in an Application Storage Group (ASG), and includes an LUN and “downstream” elements, including a SAN switch 1003f, a controller 1003g, and a disk array 1003h. The selection of particular infrastructure elements for a Subgroup is illustrated in FIGS. 38 and 39A-B, discussed below.

Based on more complete knowledge of the present application-to-storage-system mapping, the system resources associated with an application can be remapped to less constrained system resources or reconfigured, removing performance bottlenecks in the system. Each of these features and elements is described in greater detail below.

The present invention makes use of the ability to discover the data path in order to identify other resources (i.e., servers, network switches, disk controllers, disks) that may affect an application's performance when accessing data stored in the storage system. The present invention allows the user to clearly identify the when multiple applications are sharing elements in a storage systems.

The present invention utilizes a combination of agent-less methods to discover the ARG topology. These methods include utilizing existing APIs and operating system utilities to capture topology mapping information at the server, switch, adapter and disk interfaces.

In contrast, one earlier technique uses an agent-based approach that depends on hooking in to applications to be able to discover topology. This technique introduces significant overhead into the system and potentially could affect the behavior of the running application.

The present invention substantially avoids these issues. The present invention can also be easily extended to improve the reliability or security of an application by utilizing complete knowledge of both the storage system mapping and the data path between the application and the storage system.

Previous methods used to manage storage system performance have only focused on either the application or the storage system, without considering the relationship between the two. Some issues with utilizing a limited view of the system include:

(1) problems can be frequently misdiagnosed and may be caused by either application bottlenecks, e.g., server memory utilization, or storage system bottlenecks, e.g., disk controller contention, or both;

(2) there has been little consideration given to managing multiple applications or multiple servers concurrently that utilize a shared application server, network switch, or storage subsystem, and

(3) storage, network and server virtualization technologies can add an additional level of abstraction between the application and the system resources, making performance attribution even more difficult.

The present invention defines a model for tying all system resources and paths to individual applications. The invention defines a mapping from the storage device (i.e., individual disk spindle) perspective, back to individual applications. A key element of the invention is to be able to easily identify the set of applications that are associated with any point of contention in the storage system.

The invention includes the capability to obtain the storage subsystem information by capturing dynamically changing mappings between applications and the supporting storage system. This information can be obtained by periodically probing the storage system and the application in order to track any changes to the mapping.

### F. EMBODIMENTS OF MULTI-LEVEL MAPPING

The following discussion sets forth numerous specific details to provide an understanding and enabling disclosure of the invention. Those skilled in the art will appreciate that the invention may be practiced without these specific details. In other instances, well-known methods, procedures, components, protocols, algorithms, and circuits have not been described in detail so as not to obscure the invention.

The preceding discussion describes the need to map storage resources to the applications that utilize those resources. The following discussion, in connection with the attached drawing figures, describes embodiments of the present invention, operable to effectively map system resources to applications.

Turning now to FIG. 32, shown therein is an example of a computer system infrastructure 1010, including the following elements:
two application servers 1011 and 1012,
three applications 1100, 1110, and 1120,
two bus adapters 1200 and 1210,
four storage volumes 1300, 1310, 1320 and 1330,
five server LUNs 1301, 1311, 1321, 1322, and 1331,
one network switch 1400,
three disk controllers 1500, 1510, and 1520; and
three disk groups 1501, 1511, and 1521.

The underlying hardware elements of the illustrated system (i.e., the underlying servers, bus adapters, storage volumes, server LUNs, network switch, disk controllers and disk groups), as well as the applications, can be generally conventional in nature, and can be implemented by those of ordinary skill in the art using commercially available products.

It should be noted that FIG. 32 is illustrative, and provided for the purposes of the present description. For example, as mentioned above, in an actual SAN, there may be hundreds, or even thousands of LUNs. Also, a particular network may be configured differently, or contain different elements. It will be appreciated that aspects of the presently described systems and techniques may be applied in those contexts as well.

In accordance with the present invention, as implemented for example in a digital computing environment or platform such as that shown in FIG. 32, an Application Resource Group (ARG) is defined. The ARG encompasses a common set of system resources, which is defined as the complete or substantially complete mapping from a set of applications to the system elements used in the system (e.g., servers, host adapters, network switches, disk controllers and disks).

Further in accordance with the invention, an ARG includes the definition of an Application Server Group (ASerG), an Application Adapter Group (AAG), an Application Switch Group (ASwG), an Application Controller Group (ACG) and an Application Storage Group (ASG). An ARG provides a complete mapping at any point in the path between an application and the storage system.

The ARG provides a hierarchical picture of the set of applications that are generating load on any element in the storage system. When multiple applications compete for a single storage element, and when performance bottlenecks occur, the ARG can identify the set of applications that could be the cause of the bottleneck.

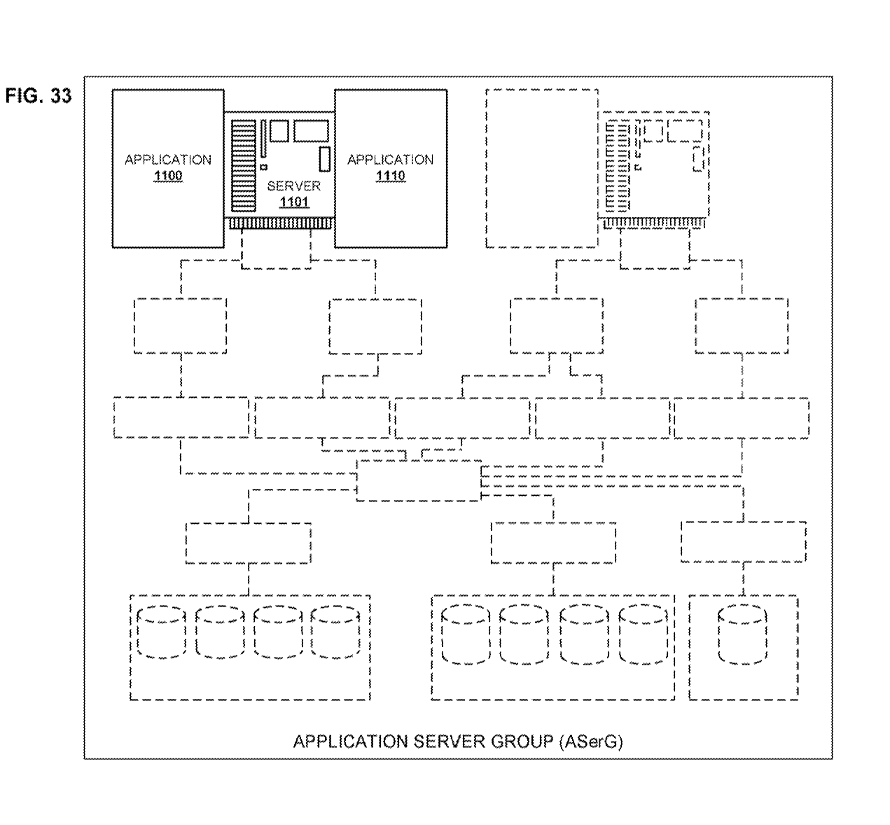

FIG. 33 shows an Application Server Group (ASerG) for Server 1011, in accordance with the invention. The ASerG identifies Applications 1100 and 1110 as the applications placing load on Server 1011.

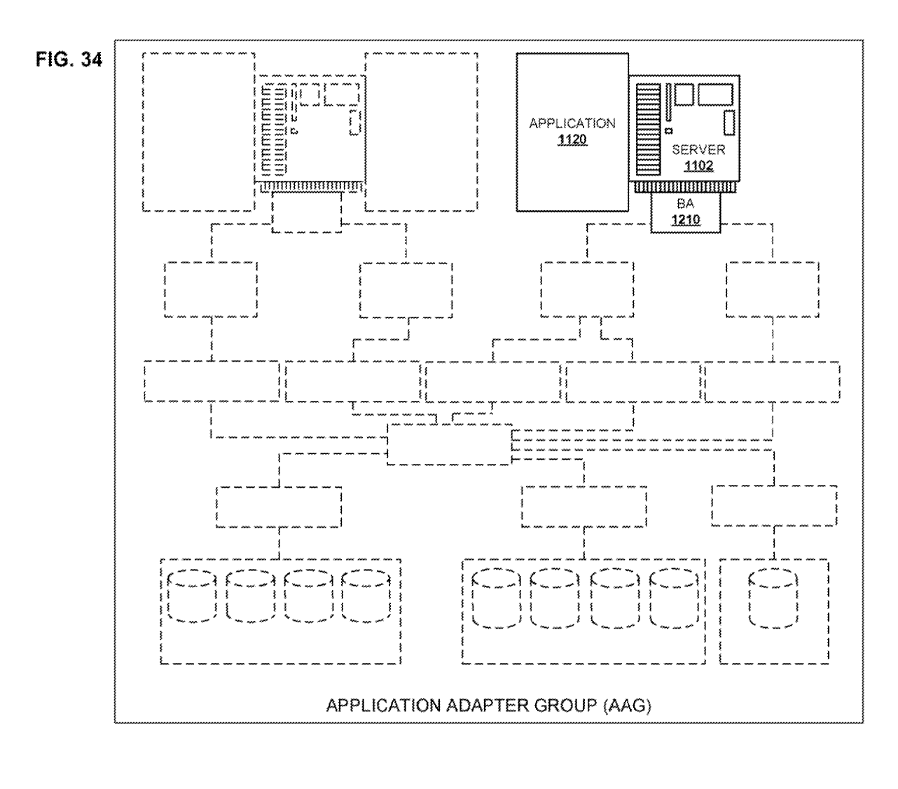

FIG. 34 shows an Application Adapter Group (AAG) for Bus Adapter 1210, in accordance with the invention. The AAG identifies Application 1120 as the application placing load on Bus Adapter 1210. The AAG also identifies that Bus Adapter 1210 is connected to Server 1012.

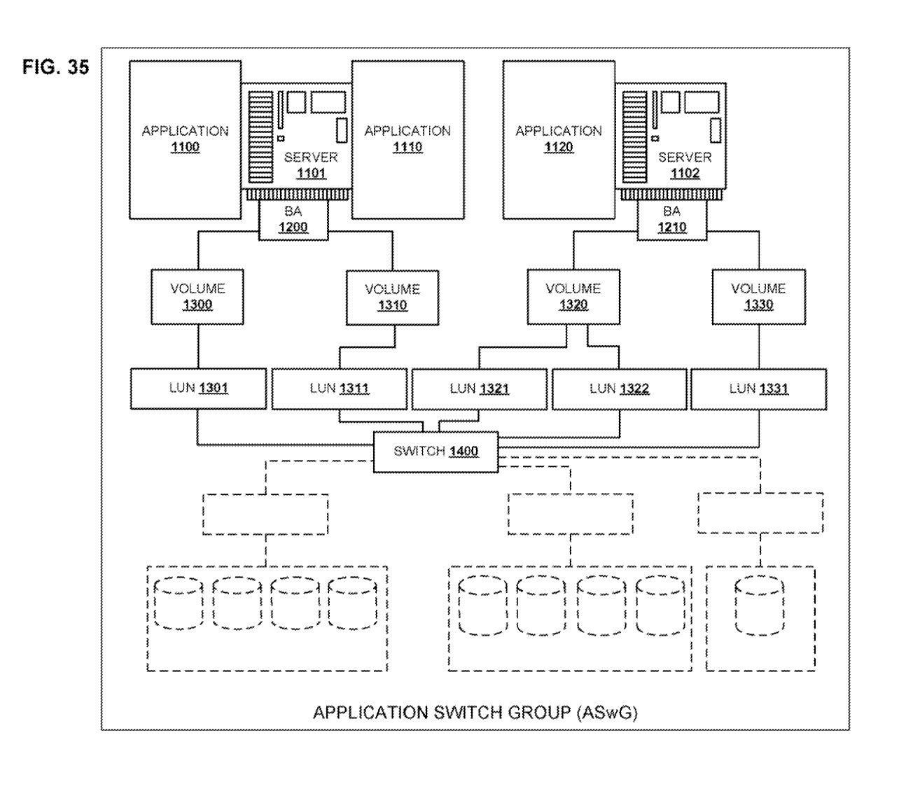

FIG. 35 shows an Application Switch Group (ASwG) for Network Switch 400, in accordance with the invention. The ASwG identifies Applications 1100, 1110 and 1120 as the applications placing load on Network Switch 400. The ASwG also identifies that Switch 1400 is connected to LUNs 1301, 1311, 1321, 1322 and 1331, which are used to map volumes 1300, 1310, 1320 and 1330, which are connected to Bus Adapters 1200 and 1210, which are connected to Servers 1011 and 1012.

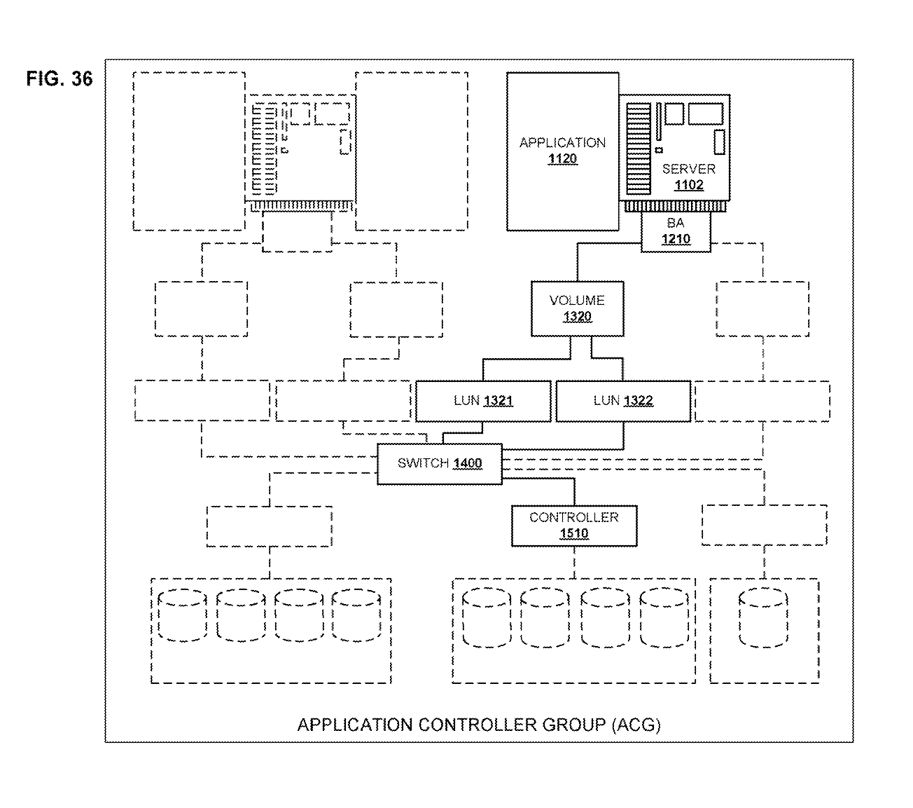

FIG. 36 shows an Application Controller Group (ACG) for Disk Controller 1510, in accordance with the invention. The ACG identifies Application 1120 as the application placing load on Disk Controller 1510. The ACG also identifies that Controller 1510 is connected to Network Switch 400, which is connected to LUNs 1321 and 1322, which are used to map volume 1320, which is connected to Bus Adapter 1210, which is connected to Server 1012.

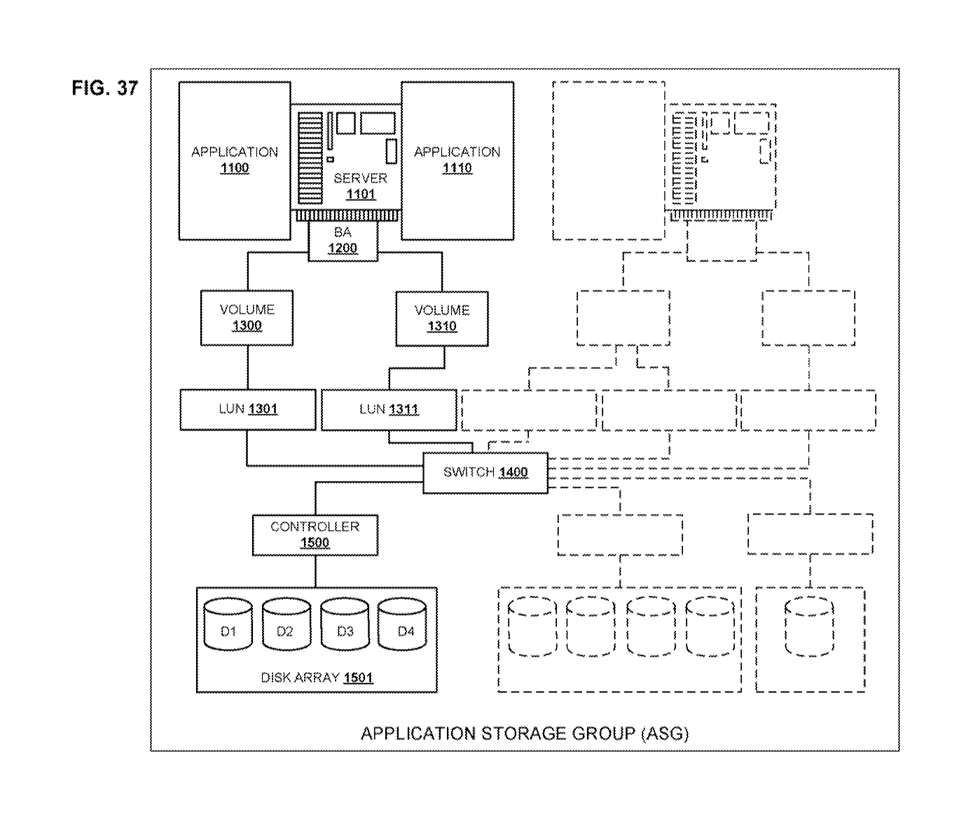

FIG. 37 shows an Application Storage Group (ASG) for Disk Array 1501, in accordance with the invention. The ASG identifies Applications 1100 and 1110 as the applications placing load on Disk Array 1501. The ASG identifies that Array 1501 is connected by Disk Controller 1500, which is connected to Network Switch 400, which is connected to LUNs 1301 and 1311, which are used to map volumes 1300 and 1310, which are connected to Bus Adapter 1200, which is connected to Server 1300.

In the subject invention, we also define a Subgroup, which further breaks down any ARG abstraction down to the LUNs associated with a single application. Each ARG abstraction (ASerG, ASwG, ASerG, ACG, and ASG) will contain at least one, and possibly multiple, Subgroups. A single Subgroup can only be present in a single ASG abstraction. The Subgroup further refines the granularity of the relationship between a single storage element and an application.

FIGS. 38 and 39A-B provide a detailed depiction of Subgroups in accordance with the invention. A Subgroup provides a more detailed picture of the LUNs associated with an application that are responsible for generating load on a storage element.

FIG. 38 shows an alternative infrastructure architecture including a host server 1013 running a single application 1130 that uses a single bus adapter 1230. The single application 1130 is mapped to multiple volumes 1350 and 1360, where each of those volumes can be mapped to multiple LUNs. Volume 1350 is mapped to LUNs 1351 and 1352, and Volume 1360 is mapped to LUN. Each LUN can be mapped to a different RAID group. LUN 1351 is mapped to Disk Array 1531, and LUNs 1352 and 1361 are mapped to Disk Array 1541.

FIG. 39A illustrates first Subgroup A 1600, comprising LUN 1351, Switch 1410, Controller 1530, and Disk Array 1531. FIG. 39B illustrates a second Subgroup B, comprising LUNs 1352 AND 1361, Switch 1410, Controller 1540, and Disk Array 1541.

A Subgroup can help to identify the LUNs associated with a single application that may be causing performance issues in a storage element. As shown for example in FIG. 39A, it would be possible to use Subgroup A 1600 to identify which specific processes within application 1130 are responsible for the load experienced in Disk Array 1531.

The information necessary to fully describe the ARG mapping for an application can be acquired though a number of methods. The information can be discovered through existing operating system interfaces (e.g., WMI for Windows) or using operating system utilities and volume managers) (e.g., Solaris Volume Manager for Solaris). Switch-level discovery uses the Simple Network Management Protocol (SNMP) APIs defined by switch manufacturers. Disk array level discovery uses the Storage Management Initiative Specification (SMI-S) APIs defined by the Storage Network Industry Association, as well as the Command Line Interface (CLI). Local to physical LUN mappings are obtained using world wide names (WWN or WWID) defined by the network, and obtained using operating system utilities on Unix or the Windows registry on Windows.

In one practice of the invention, the ARG topology may be obscured due to virtualization technology running in either the server or storage system. The discovery elements of the system can utilize the available APIs provided by the virtualization technology (for example, VMWare's ESX Collector will work with virtualized host tools). The ARG topology can then be presented to the user showing either the virtualized system elements or the actual physical elements present.

Those skilled in the art will understand that the examples of operating system interfaces noted above (WMI, Solaris Volume Manager), APIs (SMI-S, CLI and the like), and virtualization such as VMWare's ESX Collector, refer to commercially available products or services, and that the present invention can be implemented so as to be interoperable with them.

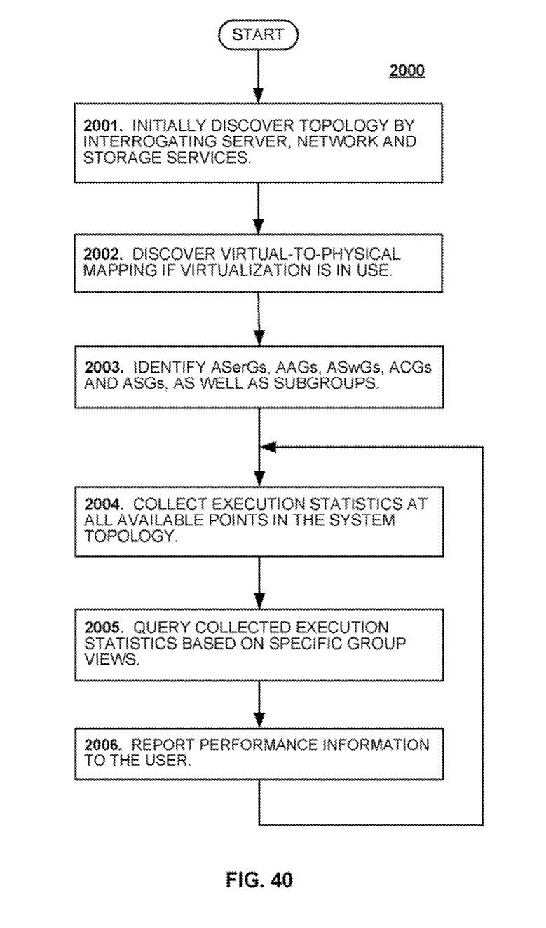

FIG. 40 provides a flowchart showing one practice 2000 of the methods and systems of the present invention, and includes the following:

Box 2001—Initially discover topology by interrogating server, network and storage services.

Box 2002—Discover any virtual-to-physical mappings present, if virtualization is in use.

Box 2003—Identify Groups ASerGs, AAGs, ASwGs, ACGs, and ASGs, as well as Subgroups.

Box 2004—Collect execution statistics at all points in the topology and store these in a statistics repository.

Box 2005—Query the collected execution statistics based on specific Group views of the topology.

Box 2006—Report performance information to the system user.

### G. CONCLUSION

While the foregoing description includes details that will enable those skilled in the art to practice the invention, it should be recognized that the description is illustrative in nature and that many modifications and variations thereof will be apparent to those skilled in the art having the benefit of these teachings, and within the spirit and scope of the present invention. It is accordingly intended that the invention herein be defined solely by the claims appended hereto and that the claims be interpreted as broadly as permitted by the prior art.

We claim:

1. In a digital storage environment comprising (A) at least one Application Server, Bus Adapter, Network Switch, Disk Controller, and Disk Array, the at least one Application Server, Bus Adapter, Network Switch, Disk Controller and Disk Array collectively being Storage Elements in the digital storage environment; and (B) at least two Applications, the improvement comprising:
(A) providing an Application Resource Group (ARG) operable to provide mapping from a set of Applications to Storage Elements used in the digital storage environment, wherein the ARG comprises ARG abstractions, the ARG abstractions comprising at least one of:
an Application Server Group (ASerG) operable to identify an Application placing load on a Server;
an Application Adapter Group (AAG) operable to identify an Application placing load on a Bus Adapter;
an Application Switch Group (ASwG) operable to identify Applications placing load on a Network Switch;
an Application Controller Group (ACG) operable to identify an Application placing load on a Disk Controller; and
an Application Storage Group (ASG) operable to identify an Application placing load on a Disk Array; and
(B) defining a Subgroup operable to refine the granularity of the relationship between a single Storage Element and an Application, wherein each ARG abstraction contains at least one Subgroup,
wherein the ARG and Subgroup are collectively operable to provide a mapping from a set of Applications to Storage Elements used in the digital storage environment, and to provide a hierarchical image of a set of Applications that are generating load on any Storage Element in the digital storage environment.

2. The improvement of claim 1 further wherein the ARG and Subgroup are collectively operable to provide a substantially complete mapping from a set of Applications to Storage Elements used in the digital storage environment.

3. The improvement of claim 1 wherein the ARG and Subgroup are collectively operable such that when multiple applications compete for a single Storage Element and create a bottleneck, the ARG can identify the set of Applications that may be the cause of the bottleneck.

4. The improvement of claim 1 further wherein ASG abstractions are configured such that a single Subgroup can only be present in a single ASG abstraction.

5. In a digital storage environment comprising (A) at least one Application Server, Bus Adapter, Network Switch, Disk Controller, and Disk Array, the at least one Application Server, Bus Adapter, Network Switch, Disk Controller and Disk Array collectively being Storage Elements in the digital storage environment; and (B) at least two Applications, the improvement comprising:
(A) means for providing an Application Resource Group (ARG) operable to provide mapping from a set of Applications to Storage Elements used in the digital storage environment, wherein the ARG comprises ARG abstractions, the ARG abstractions comprising at least one of:
an Application Server Group (ASerG) operable to identify an Application placing load on a Server;
an Application Adapter Group (AAG) operable to identify an Application placing load on a Bus Adapter;
an Application Switch Group (ASwG) operable to identify Applications placing load on a Network Switch;
an Application Controller Group (ACG) operable to identify an Application placing load on a Disk Controller; and
an Application Storage Group (ASG) operable to identify an Application placing load on a Disk Array; and
(B) means for defining a Subgroup operable to refine the granularity of the relationship between a single Storage Element and an Application, wherein each ARG abstraction contains at least one Subgroup, wherein the ARG and Subgroup are collectively operable to provide a mapping from a set of Applications to Storage Elements used in the digital storage environment, and to provide a hierarchical image of a set of Applications that are generating load on any Storage Element in the digital storage environment.

6. The improvement of claim 5 wherein the ARG and Subgroup are collectively operable to provide a substantially complete mapping from a set of Applications to Storage Elements used in the digital storage environment.

7. The improvement of claim 5 wherein the ARG and Subgroup are collectively operable such that when multiple applications compete for a single Storage Element and create a bottleneck, the ARG can identify the set of Applications that may be the cause of the bottleneck.

8. The improvement of claim 5 wherein ASG abstractions are configured such that a single Subgroup can only be present in a single ASG abstraction.

9. A computer program product stored on a computer-readable medium and operable in a digital storage environment comprising (A) at least one Application Server, Bus Adapter, Network Switch, Disk Controller, and Disk Array, the at least one Application Server, Bus Adapter, Network Switch, Disk Controller and Disk Array collectively being Storage Elements in the digital storage environment; and (B) at least two Applications, the computer program product comprising:
(A) computer program code means executable in the digital storage environment for providing an Application Resource Group (ARG) operable to provide mapping from a set of Applications to Storage Elements used in the digital storage environment, wherein the ARG comprises ARG abstractions, the ARG abstractions comprising at least one of:
an Application Server Group (ASerG) operable to identify an Application placing load on a Server;
an Application Adapter Group (AAG) operable to identify an Application placing load on a Bus Adapter;
an Application Switch Group (ASwG) operable to identify Applications placing load on a Network Switch;
an Application Controller Group (ACG) operable to identify an Application placing load on a Disk Controller; and
an Application Storage Group (ASG) operable to identify an Application placing load on a Disk Array; and
(B) computer program code means for defining a Subgroup operable to refine the granularity of the relationship between a single Storage Element and an Application, wherein each ARG abstraction contains at least one Subgroup, wherein the ARG and Subgroup are collectively operable to provide a mapping from a set of Applications to Storage Elements used in the digital storage environment, and to provide a hierarchical image of a set of Applications that are generating load on any Storage Element in the digital storage environment.

10. The computer program product of claim 9 wherein the ARG and Subgroup are collectively operable to provide a substantially complete mapping from a set of Applications to Storage Elements used in the digital storage environment.

11. The computer program product of claim 9 wherein the ARG and Subgroup are collectively operable such that when multiple applications compete for a single Storage Element and create a bottleneck, the ARG can identify the set of Applications that may be the cause of the bottleneck.

12. The computer program product of claim 9 wherein ASG abstractions are configured such that a single Subgroup can only be present in a single ASG abstraction.

13. A method for enabling a mapping from a set of Applications to Storage Elements used in a digital storage environment, the method being executable in a digital storage environment comprising (A) at least one Application Server, Bus Adapter, Network Switch, Disk Controller, and Disk Array, the at least one Application Server, Bus Adapter, Network Switch, Disk Controller and Disk Array collectively being Storage Elements in the digital storage environment; and (B) at least two Applications, the method comprising:
(A) providing an Application Resource Group (ARG) operable to provide mapping from a set of Applications to Storage Elements used in the digital storage environment, wherein the ARG comprises ARG abstractions, the ARG abstractions comprising at least one of:
an Application Server Group (ASerG) operable to identify an Application placing load on a Server;
an Application Adapter Group (AAG) operable to identify an Application placing load on a Bus Adapter;
an Application Switch Group (ASWG) operable to identify Applications placing load on a Network Switch;
an Application Controller Group (ACG) operable to identify an Application placing load on a Disk Controller; and
an Application Storage Group (ASG) operable to identify an Application placing load on a Disk Array; and
(B) defining a Subgroup operable to refine the granularity of the relationship between a single Storage Element and an Application, wherein each ARG abstraction contains at least one Subgroup,
wherein the ARG and Subgroup are collectively operable to provide a mapping from a set of Applications to Storage Elements used in the digital storage environment, and to provide a hierarchical image of a set of Applications that are generating load on any Storage Element in the digital storage environment.

14. The method of claim 1 further wherein the ARG and Subgroup are collectively operable to provide a substantially complete mapping from a set of Applications to Storage Elements used in the digital storage environment.

15. The method of claim 1 wherein the ARG and Subgroup are collectively operable such that when multiple applications compete for a single Storage Element and create a bottleneck, the ARG can identify the set of Applications that may be the cause of the bottleneck.

16. The method of claim 1 further wherein ASG abstractions are configured such that a single Subgroup can only be present in a single ASG abstraction.

17. A system for enabling a mapping from a set of Applications to Storage Elements used in a digital storage environment, the system being implementable in a digital storage environment comprising (A) at least one Application Server, Bus Adapter, Network Switch, Disk Controller, and Disk Array, the at least one Application Server, Bus Adapter, Network Switch, Disk Controller and Disk Array collectively being Storage Elements in the digital storage environment; and (B) at least two Applications, the system comprising:
(A) means for providing an Application Resource Group (ARG) operable to provide mapping from a set of Applications to Storage Elements used in the digital storage environment, wherein the ARG comprises ARG abstractions, the ARG abstractions comprising at least one of:
an Application Server Group (ASerG) operable to identify an Application placing load on a Server;
an Application Adapter Group (AAG) operable to identify an Application placing load on a Bus Adapter;
an Application Switch Group (ASwG) operable to identify Applications placing load on a Network Switch;
an Application Controller Group (ACG) operable to identify an Application placing load on a Disk Controller; and
an Application Storage Group (ASG) operable to identify an Application placing load on a Disk Array; and
(B) means for defining a Subgroup operable to refine the granularity of the relationship between a single Storage Element and an Application, wherein each ARG abstraction contains at least one Subgroup,
wherein the ARG and Subgroup are collectively operable to provide a mapping from a set of Applications to Storage Elements used in the digital storage environment, and to provide a hierarchical image of a set of Applications that are generating load on any Storage Element in the digital storage environment.
